(19) United States
(12) Patent Application Publication
(10) Pub. No.: US 2006/0260885 A1
(43) Pub. Date: Nov. 23, 2006

(54) Floating caliper type disc brake

(75) Inventor: Toshifumi Maehara, Tokyo (JP)

Correspondence Address: MORGAN LEWIS & BOCKIUS LLP, 1111 PENNSYLVANIA AVENUE NW, WASHINGTON, DC, 20004, US

(73) Assignee: Akebono Brake Industry Co., Ltd.

(21) Appl. No.: 11/434,792

(22) Filed: May 17, 2006

(30) Foreign Application Priority Data
May 20, 2005 (JP) 2005-147563
Jul. 1, 2005 (JP) 2005-193356

(51) Int. Cl. F16D 55/00

(52) U.S. Cl. 188/71.1

(57) ABSTRACT

A support member is provided with an inner side attaching member and a pair of torque receiving members. Each of the torque receiving members is provided with a drawing anchor portion. A cross-section of the drawing anchor portion is formed into an L-shape, an end portion of which is bent to an outer diameter side of the rotor. An engaging protrusion is provided in a pad. The engaging protrusion is opposed to the drawing anchor portion in the circumferential direction.

The present application claims foreign priority based on Japanese Patent Application No. P.2005-147563 filed on May 20, 2005, and No. P.2005-193356 filed on Jul. 1, 2005, the contents of them are incorporated herein by reference.

### BACKGROUND OF THE INVENTION

1. Field of the Invention

The present invention relates to a floating caliper type disc brake for applying brake in a vehicle such as an automobile.

2. Related Art

In a floating caliper type disc brake, a caliper is supported with respect to a support member in such a manner that the caliper is movable in an axial direction of a rotor and a cylinder and a piston are provided only on one side of the caliper with respect to the rotor.

Concerning the floating caliper type disc brake, various structures are provided according to the caliper holding method and the sliding method. For example, in the case of a structure referred to as a pin slide type disc brake which is the main stream at present, a caliper is supported by a support member so that the caliper can be freely displaced being guided by a guide pin. FIGS. 31 and 32 are views showing the pin slide type disc brake disclosed in JP-A-03-194224. In the floating caliper type disc brake of the pin slide type, at the time of conducting a braking operation, a caliper 2 is displaced with respect to a rotor 1 which is rotated together with a wheel not shown. In a state in which the floating caliper type disc brake is incorporated into a vehicle, a support member 3, which is provided being adjacent to one side of the rotor 1, is fixed to a vehicle body not shown via an attaching hole 4. The caliper 2 is supported by the support member 3 so that the caliper 2 can be displaced in the axial direction of the rotor 1.

Therefore, at both end portions in the width direction of the caliper 2 with respect to the rotary direction of the rotor 1, a pair of guide pins 5 are arranged in parallel with the central axis of the rotor 1. In the same manner, at both end portions of the support member 3, a pair of guide holes 6 are arranged in parallel with the central axis of the rotor 1. Both the guide pins 5 are inserted into both the guide holes 6 so that the guide pins 5 can freely slide in the axial direction. Dust-proof boots 7, 7 are provided between circumferential faces of the base end portions of both the guide pins 5 and the opening portions of both the guide holes 6.

At both end portions the above support member 3 which are separate from each other in the circumferential direction of the rotor 1, both an entry rotation side engaging portion 8 and a delivery rotation side engaging portion 9 are respectively arranged. A forward end portion of each engaging portion 8, 9 is curved into a U-shape in such a manner that the forward end portion crosses an outer circumferential portion of the rotor 1 in the upward and downward direction of FIG. 31. Both end portions of pressure plates 11, 11 composing pads 10a, 10b are engaged with both the engaging portions 8, 9 so that both the end portions of pressure plates 11, 11 can be slid in the axial direction of the rotor 1. The caliper 2 having a cylinder portion 12 and a claw portion 13 is arranged in such a manner that the caliper 2 crosses the pads 10a, 10b. Into the cylinder portion 12, a piston 14, which pushes the pad 10a on the inner side (the upper side of FIG. 31 on the inside in the width direction of a vehicle) with respect to the rotor 1, is liquid-tightly incorporated.

In the case of applying the brakes, operation is conducted as follows. Hydraulic fluid is supplied into the cylinder portion 12. By the aforementioned piston 14, a lining 15 of the inner side pad 10a is pressed onto the inner side of the rotor 1 from top to bottom in FIG. 31. Then, as a reaction of the pressing force, the caliper 2 is displaced upward in FIG. 31 by the sliding motions of both guide pins 5 and both guide holes 6. Therefore, the claw portion 13 presses the lining 15 of the pad 10b on the outer side (the lower side of FIG. 31 on the outside in the width direction of a vehicle) onto the outer side of the rotor 1. As a result, the rotor 1 is strongly interposed between both sides of the inside and the outside. In the way, the braking operation is conducted.

In the structure shown in FIGS. 31 and 32, the entry rotation side and the delivery rotation side engaging portion 8, 9 are engaged with the end portions of the pressure plates 11, 11 composing the pads 10a, 10b. Therefore, braking torque, which is generated in each pad 10a, 10b at the time of braking operation when the vehicle is running forward, is received by the support member only through the delivery rotation side engaging portion 9 located on the front side in the rotary direction (the direction shown by arrow “a” in FIGS. 31 and 32) of the rotor 1. In the case, in the case where consideration is not particularly given to ensuring the mechanical strength of the delivery rotation side engaging portion 9, the delivery rotation side engaging portion 9 is likely to be deformed when it receives braking torque at the time of braking operation. On the other hand, in the case of the structure shown in FIGS. 31 and 32, the outer side end portions of the entry rotation side and the delivery rotation side engaging portion 8, 9 are connected to each other by a reinforcing portion 18. Therefore, when the rigidity of the reinforcing portion 18 is ensured, the delivery rotation side engaging portion 9 can be prevented from being deformed. However, when a cross-sectional area of the reinforcing portion 18 is increased in order to enhance the rigidity of the reinforcing portion 18, the weight is increased. Existence of the reinforcing portion 18 obstructs a great reduction of the weight of the floating caliper type disc brake. Further, it is difficult to ensure a sufficiently large space to accommodate the floating caliper type disc brake around the wheel.

In addition, in the floating caliper disc brake of FIGS. 31 and 32, the support member 3 strides across an outer circumferential portion of the rotor 1 between both sides of the rotor 1 in the axial direction of the rotor 1. If the support member 3 is manufactured by a method such as metal casting, since the support member has a complicated shape, it is needed to carry out machining processes to a part of the support member 3. That is, it is needed to form engagement portions 75 on inner and outer sides of the support, so that the engagement portions 75 engage with both ends of the pads 10a, 10b. The parts of the support member 3 where the engagement portions 75 are needed to be carried out the machining processes. However, in the conventional disc brake, since the support member 3 has complicated shape, the machining processes are troublesome tasks, and it become the reason to increase a total cost of the disc brake.

In contrast, it is considered to structure the support member by an inner side attaching member disposed inner side of the rotor and torque receiving members fixed to the inner side attaching member at out sides of the inner side attaching member. Then, the inner side attaching member and the torque receiving members are fixed by fastening means such as welding or bolt fastening. If the support member is structured by the above construction, since it is only necessary to provide portions to be engaged with the pads on the torque receiving members that are small sized and relatively simple shaped, the machining processes may be easy carried out. However, if the inner side attaching member and the torque receiving members are fastened by welding, a operation of the welding becomes the trouble task. If the inner side attaching member and the torque receiving members are fastened by bolt fastening, a total number of parts of the support member become increased. Therefore, in the above construction of the support member, there is room for improvement in a viewpoint of a manufacturing cost.

In addition, in the disc brake having the above support member with the inner side attaching member and torque receiving members fixed to the inner side attaching member by welding or bolt fastening, when a large braking torque is applied to the torque receiving member from the pads, the braking torque is transmitted to the inner side attaching member via a fixing portion by the welding or the bolt fastening. As a result, a large force may be applied to the fixing portion. Therefore, there also is room for improvement in a viewpoint of durability.

Further, the following patent publications also discloses conventional floating caliper type disc brakes:

JP-A-54-156972;

JP-U-54-030180;

JP-A-2001-193769; and

JP-U-57-165830.

### SUMMARY OF THE INVENTION

One or more embodiments of the present invention provide a floating caliper type disc brake in which a manufacturing cost is low and a weight is light, which is capable of sufficiently suppressing a generation of deformation of a support member during braking, and in which durability of the support member is high.

In accordance with one or more embodiments of the present invention, a floating caliper type disc brake is provided with:

a support member fixed to a vehicle body, being adjacent to a rotor rotated together with a wheel; a pair of pads arranged on both sides of the rotor in an axial direction of the rotor, guided by the support member being capable of moving in the axial direction; and a caliper. The caliper is provided with: a bridge portion striding across the rotor and the pair of pads; a claw portion arranged on one side of a bridge portion; and a cylinder portion arranged on the other side of the bridge portion, wherein a piston is incorporated to the cylinder portion. The support member is provided with: an inner side attaching member arranged at a position shifted to an inner side with respect to the rotor; a pair of torque receiving members provided on both end portions in a circumferential direction of the rotor of the inner side attaching member; and a drawing anchor portion provided on at least one of the pair of the torque receiving members. An end portion of the drawing anchor portion is bent in a radial direction of the rotor. An inside surface of the end portion of the drawing anchor at a side in the circumferential direction of the rotor and an engaging portion in one end portion of at least one of the pads are arranged being opposed to each other in the circumferential direction of the rotor.

In the case of the floating caliper type disc brake of the present invention composed as described above, when a portion of the braking torque given to one of the pads is received by a rear side in the rotary direction of the rotor of the other torque receiving member in the pair of torque receiving members, in the case where an intensity of the braking torque is increased relatively high, a portion of the braking torque can be received by the forward end portion of the drawing anchor portion provided in one torque receiving member. Therefore, it is possible to prevent an excessively high intensity of torque from concentrating upon a portion of the support. Accordingly, the support member can be sufficiently prevented from being deformed. Further, it is possible to eliminate a reinforcing portion for connecting the outer side end portions of a pair of torque receiving members. Alternatively, even in the case where the reinforcing portion exists, it is possible to decrease a cross-sectional area of the reinforcing portion. Therefore, the weight of the disc brake can be reduced while the support member is prevented from being deformed, and a space for accommodating the disc brake can be easily ensured around the wheel.

In addition, one of the torque receiving members can be made to be a small part. Therefore, although a profile of the one of the torque receiving members becomes complicated because it has a drawing anchor portion, the drawing anchor portion can be easily formed by the modified forming such as drawing or extrusion. On the other hand, in the case of forming a drawing anchor portion in a portion of an integrated large support, it is necessary to form the drawing anchor portion by means of cutting. Therefore, it takes time to conduct machining. Further, it is necessary to put an edge of a cutting tool into a small space, that is, the machining work becomes difficult. According to the present invention, it is possible to solve the above problems. As a result, according to the present invention, it is possible to sufficiently prevent the occurrence of deformation of the support member at the time of braking operation by an inexpensive and light structure.

In accordance with one or more embodiments of the present invention, in a second aspect, a holder may be provided between the caliper and the pair of pads. The caliper is supported to the pads by the holding means being capable of engaging with and disengaging from the support member, while the caliper is slidable in the axial direction of the rotor.

In the structure of the second aspect, when each pad is supported by the support, being different from the conventional structure shown in FIGS. 31 and 32, the caliper can be moved in the axial direction of the rotor with respect to the support. Therefore, it is unnecessary to employ a structure in which the guide pin joined to the caliper is slid in the guide hole formed in the support. Accordingly, it becomes unnecessary to use a bolt for joining the guide pin to the caliper. Further, it is unnecessary to form a through-hole for inserting the bolt into the caliper. Furthermore, it is unnecessary to form the guide hole in the support. Therefore, it is possible to obtain a light and inexpensive structure. In the case where the guide hole is formed, it is necessary to accurately machine an inner circumferential face of the guide hole. However, in the structure of the second aspect, the complicated machining work can be eliminated.

In addition, in accordance with one or more embodiments of the present invention, the holder may include: a holding member, the movement to the outside in the radial direction of the rotor of which is restricted by an engagement with a pair of pads; and an engagement member for restricting a movement in the radial direction of the rotor of the caliper being engaged with the holding member inserted into the opening portion provided in the caliper bridge portion under the condition that the opening portion penetrates in the radial direction of the rotor.

Due to the above structure, the caliper is guided so that each pad can be moved in the axial direction of the rotor. Therefore, it is unnecessary that hole portions used for the insertion of guide pins are formed in the caliper and each pad. Therefore, the manufacturing cost can be easily reduced.

Further, in accordance with one or more embodiments, in a third aspect, the drawing anchor may be disposed on an anchor portion, the anchor portion being provided on at least one end portion in a longitudinal direction of the one of the pair of the torque receiving members. The anchor portion includes a recessed groove having two inner wall faces, which are opposed to each other in the radial direction of the rotor, and also having two inner wall faces, which are opposed to each other in the circumferential direction of the rotor. The recessed groove is capable of engaging with the engaging portion of the one of the pads, the engaging portion being formed on one end portion of a pressure plate of the one of the pads.

According to the structure of the third aspect, a profile of the anchor portion having the drawing anchor portion becomes complicated. Therefore, the support member includes: an inner side attaching member arranged at a position shifted to the inner side with respect to the rotor; and a pair of torque receiving members joined to both end portions in the circumferential direction of the rotor of the inner side attaching portion. When the structure of the support member is adopted, the torque receiving member having the above anchor portion can be easily machined, and the manufacturing cost can be reduced.

Further, in accordance with one or more embodiments of the present invention, in a fourth aspect, the drawing anchor portion may be arranged only on the outer side with respect to the rotor of at least one of the torque receiving members.

According to the structure of the fourth aspect, the torque receiving member can be easily formed by means of header working. On the other hand, in the case where a pair of drawing anchor portions are arranged on both the inner and the outer side with respect to the rotor of the torque receiving member being different from the structure of the fourth aspect, it is necessary to arrange a recess portion between these drawing anchor portions in such a manner that the recess portion crosses the rotor. In the case, it is difficult to push a punch, which is used for machining, to a material, which composes the torque receiving member, from the side of a portion which becomes the drawing anchor portion. Therefore, it is impossible to form the torque receiving member by means of header working. However, according to the structure of the fourth aspect, it is sufficient that the drawing anchor portion is provided only in one portion of the torque receiving member. Therefore, it becomes unnecessary to provide a recess portion which is recessed in such a manner that the recess portion crosses the rotor. Therefore, the torque receiving member can be easily formed by means of header working.

In the case where braking torque is given to the torque receiving member from each pad, with respect to the torque receiving member, a distance from the outer side pad to the attaching portion of the inner side attaching member, which is used as a fulcrum, is so long that a high intensity of moment is given to the outer side. Further, when a reinforcing portion for connecting the outer side portions is eliminated, a displacement on the outer side becomes larger than a displacement on the inner side. According to the structure of the fourth aspect, on the outer side, the braking torque can be received by a pair of torque receiving members being shared. Therefore, the support member can be more effectively prevented from being deformed. On the other hand, in the case where the drawing anchor is provided only on the inner side of both the inner and the outer side of the torque receiving member and the braking toque is received by the pair of torque receiving members only on the inner side, a distance between a point of application of the force given from the inner side pad to the torque receiving member and the attaching portion of the inner side attaching member is small and the moment acting on the inner side is low. Therefore, even when the moment is received being shared, the obtained effect is low, that is, it is impossible to provide a sufficiently high effect for suppressing a displacement in the outer side portion of the support. For the above reasons, it is difficult to effectively suppress a deformation of the support. According to the structure of the fourth aspect, it is possible to solve the above problems and the deformation of the support member can be effectively suppressed.

Further, in accordance with one or more embodiments of the present invention, in a fifth aspect, the drawing anchor portion may be arranged only on the outer side with respect to the rotor of the torque receiving member which is on the rear side (the entry rotation side) in the rotary direction of the rotor in the case where a vehicle advances forward.

According to the structure of the fifth aspect, it is sufficient that only one anchor portion is provided in the support. Therefore, the torque receiving member can be more easily manufactured. In the connection, in the case where the drawing anchor portion is arranged on the front side (the delivery rotation side) in the rotary direction of the rotor when the vehicle runs forward, only when braking operation is conducted on a vehicle which is running backward, the drawing anchor receives the braking torque, that is, the frequency is low. Further, when braking operation is conducted on a vehicle which is running backward, an intensity of the braking torque is usually low. Therefore, an influence, which is produced when no drawing anchor exists on the delivery rotation side, is practically small.

Further, in accordance with one or more embodiments of the present invention, in a sixth aspect, the caliper may be given an elastic force in the outer radial direction and the circumferential direction of the rotor by a pad clip attached to the torque receiving member.

According to the structure of the sixth aspect, the pad clip having a function of suppressing the generation of rattling of each pad with respect to the support member can suppress rattling of the caliper. Therefore, it is unnecessary that another member, which is different from the pad clip, such as a hold spring is provided in order to suppress the generation of rattling of the caliper. Accordingly, the number of parts can be decreased. By the same method as that conventionally conducted, the pad clip can be easily attached to the support member before the caliper is incorporated into the support. In the case where the caliper is incorporated into the support, the caliper may be incorporated into the support member while the caliper is being pushed to the pad clip, resisting an elastic force. The caliper is put on upper faces of both end portions in the circumferential direction of the rotor, so that an elastic force can be given outward in the radial direction of the caliper. Therefore, unlike a hold spring, it is unnecessary to give a special consideration of holding it with a hand so that it can not fall off. Accordingly, it is possible to enhance the assembling property.

Further, in accordance with one or more embodiments of the present embodiments, in a seventh aspect, a pair of elastic members may be detachably engaged with both end portions of the caliper with respect to the circumferential direction of the rotor in such a manner that the pair of elastic members cross an outer circumference of the rotor, and when the elastic members are elastically pushed to the support, the caliper is given an elastic force in the outer radial direction and the circumferential direction of the rotor by the elastic members. At the same time, when each elastic member is elastically pressed to the support, each elastic member gives an elastic force to the caliper outward in the radial direction and in the circumferential direction of the rotor.

According to the structure of the seventh aspect, each elastic member can suppress the occurrence of rattling of the caliper. At the same time, even at the time of applying the brakes, the caliper and the elastic member can not be slid on each other. Therefore, being different from a case in which a portion of the elastic member is pressed to and slid on the caliper so as to suppress the generation of rattling, it becomes unnecessary to provide a working face, which is used for sliding the elastic member, on the caliper. Accordingly, it becomes unnecessary to conduct a machining work of finishing the working face with high accuracy. In the case where the elastic member engaged with the caliper is formed out of a wire rod, a sliding contact portion of each elastic member with the support member can be formed into a linear shape. Therefore, the caliper can be more smoothly displaced with respect to the support member in the axial direction of the rotor.

Moreover, in accordance with one or more embodiments of the present invention, a floating caliper type disc brake is provided with: a support member fixed to a vehicle body, being adjacent to a rotor rotated together with a wheel; a pair of pads arranged on both sides of the rotor in an axial direction of the rotor, guided by the support member being capable of moving in the axial direction; a caliper. The caliper is provided with: a bridge portion striding across the rotor and the pair of pads; a claw portion arranged on one side of a bridge portion; and a cylinder portion arranged on the other side of the bridge portion, where in a piston is incorporated to the cylinder portion. The support member is provided with: an inner side attaching member arranged at a position shifted to an inner side with respect to the rotor, wherein a pair of first through-holes are formed in the inner side attaching member in both end portions in a circumference direction of the rotor; and a pair of torque receiving members provided on both end portions in a circumferential direction of the rotor of the inner side attaching member, wherein each of the torque receiving member has an inner protrusion on a inner side surface. Each of the torque receiving members is fastened to the inner side attaching member by inserting the protrusion into the through-hole and caulking a portion of the protrusion protruded from an inner side surface of the inner side attaching member, and a center side surface in a width direction of the inner side attaching member in a vicinity of the through-hole is firmly contact with a side surface of the torque receiving member.

According to the floating caliper type disc brake of the above structure, the inner side attaching member can be formed in a flat (having constant shape in the axial direction of the rotor) and simple shape, and the torque receiving members also can be formed in a simple shapes. Thereby, it become easy to carry out the machining processes for the fixing portion to the inner side attaching member and the portion for receiving the braking torque from the pads of the torque receiving member. In addition, the torque receiving member can be a small part, the torque receiving member can be formed by a forging process. When the torque receiving member is formed by the forging process, the manufacturing cost become lower than the case that the torque receiving member is formed by a cutting process to a material for the torque receiving member. As a result, a total manufacturing cost of the disc brake can be reduced.

In addition, according to the above structure, the torque receiving members and the inner side attaching member are fixed by caulking a portion of the protrusion of the torque receiving member protruded from the through-hole to the inner side surface of the inner side attaching member. Therefore, it is not needed to use a bolt or welding means so as to fix the inner side attaching member and the torque receiving members. As a result, the inner side attaching member and the torque receiving members can be fastened in a short time and low cost, so that the total manufacturing cost of the disc brake is reduced.

Moreover, in a peripheral portion of the through-hole of the inner side attaching member, since the peripheral portion of the through-hole is deformed so that the through-hole expands by the caulking process, the center side surface in the width direction in the vicinity of the through-hole is firmly contact with the side surface of the torque receiving member, so that the inner side attaching member and the torque receiving member are pushed with each other. Therefore, at least a part of braking torque applied to the pad during braking is transmitted to the inner side attaching member, via a contact portion between the center side surface in the width direction in the vicinity of the through-hole and the inner side surface of the torque receiving portion, without transmitted through the protrusion of the torque receiving member. As a result, a stress applied to a caulking portion of the protrusion is reduced, so that a strength of the support member can be held enough and the durability of the support member can be improved.

Other aspects and advantages of the invention will be apparent from the following description and the appended claims.

### BRIEF DESCRIPTION OF THE DRAWINGS

FIG. 1 is a perspective view of a disc brake of a first exemplary embodiment of the present invention, wherein a rotor is omitted in the view.

FIG. 2 is a view of the disc brake of the first exemplary embodiment, wherein the view is taken from the outer diameter side of the rotor.

FIG. 3 is a view taken from the right of FIG. 2.

FIG. 4 is a sectional view taken on line A-A in FIG. 2.

FIG. 5 is a sectional view taken on line B-B in FIG. 2.

FIG. 6 is an exploded perspective view of a support.

FIG. 7 is a view of a right torque receiving member of FIG. 6, wherein the view is taken from the inner side.

FIG. 8 is a perspective view showing a state in which a pad clip is attached to a support.

FIG. 9 is a perspective view showing a state in which a pad is incorporated into the support member to which the pad clip is attached.

FIG. 10 is a perspective view showing a state in which a holding member is engaged with each pad supported by the support.

FIG. 11 is a perspective view showing a state in which a caliper is incorporated into the support member and the pad.

FIG. 12 is a perspective view showing a state in which a lock plate is inserted into a holding member after the caliper has been incorporated into the support member and the pad.

FIG. 13 is an enlarged view of portion C in FIG. 3.

FIG. 14 is a sectional view showing a state in which braking torque is received from an outer side pad to a support member at the time of applying the brakes in which an intensity of braking torque is relatively low.

FIG. 15 is a sectional view showing a state in which braking torque is received from an outer side pad to a support member at the time of applying the brakes in which an intensity of braking torque is relatively high.

FIG. 16 is a perspective view showing a second exemplary embodiment of the present invention in which a pair of pads are engaged with a support.

FIG. 17 is an exploded perspective view showing a support member composing a disc brake of the second exemplary embodiment.

FIG. 18 is a perspective view showing a state before a pad clip is attached to the support.

FIG. 19 is a perspective view showing a state after the pad clip is attached to the support.

FIG. 20 is a view showing a third exemplary embodiment of the present invention, wherein FIG. 20 is almost the same as FIG. 14.

FIG. 21 is a perspective view showing a disc brake of a fourth exemplary embodiment, wherein a rotor is omitted in the view.

FIG. 22 is a view of the disc brake of FIG. 21, wherein the view is taken from the inside in the radial direction of the rotor.

FIG. 23 is a view taken from the above of FIG. 22.

FIG. 24 is a view taken from the left of FIG. 23.

FIG. 25 is a perspective view showing a pair of springs for pushing which are used in the fourth exemplary embodiment.

FIG. 26 is a perspective view showing a state in which a spring for pushing is engaged with a caliper, wherein the view is taken from an outer diameter side of a rotor.

FIG. 27 is a perspective view taken from the inside in the radial direction of the rotor.

FIG. 28 is a perspective view showing a state in which a lock plate is inserted into a holding member after a caliper is supported by a support.

FIG. 29 is an enlarged view of C portion of FIG. 3, wherein a protrusion of the torque receiving member is inserted into a through-hole of the inner side attaching member.

FIG. 30 is a sectional view taken on line D-D in FIG. 29.

FIG. 31 is a view showing an example of the conventional structure, wherein the view is taken from the outer diameter side of a rotor.

FIG. 32 is a view showing a left half of FIG. 31, wherein the view is taken from the below.

### DETAILED DESCRIPTION OF THE EXEMPLARY EMBODIMENTS

Exemplary embodiments of the invention will be described with reference to the accompanying drawings.

### First Exemplary Embodiment

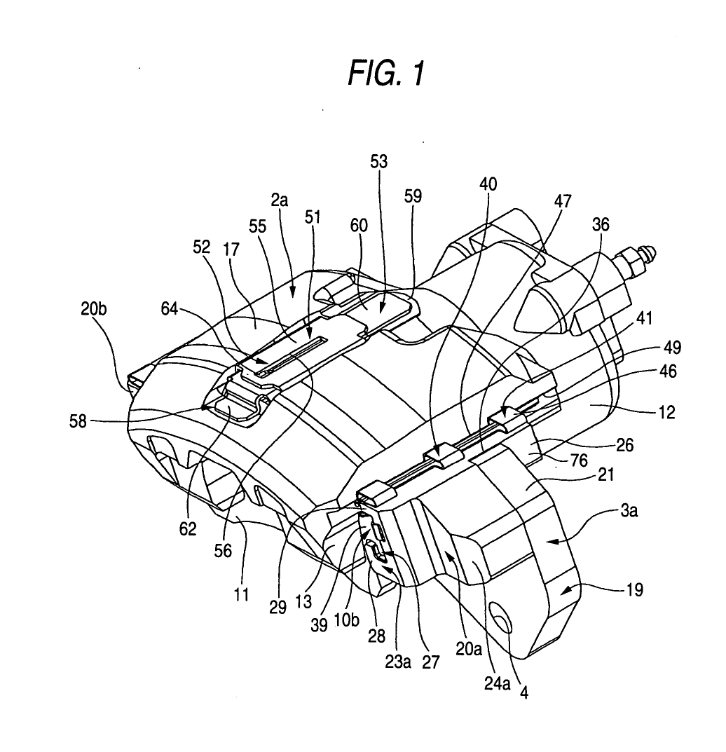

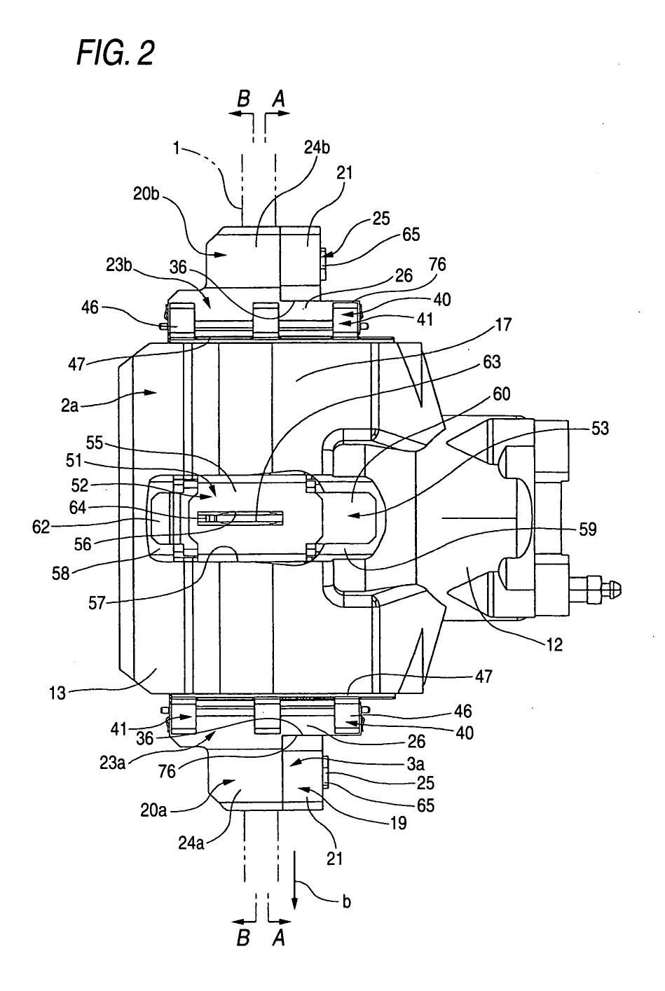

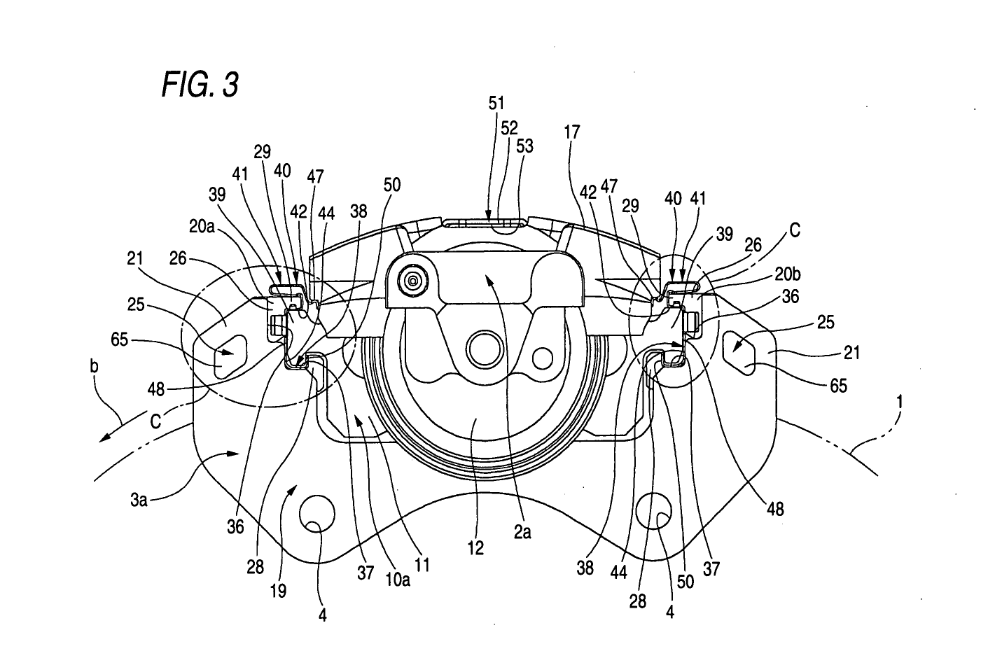

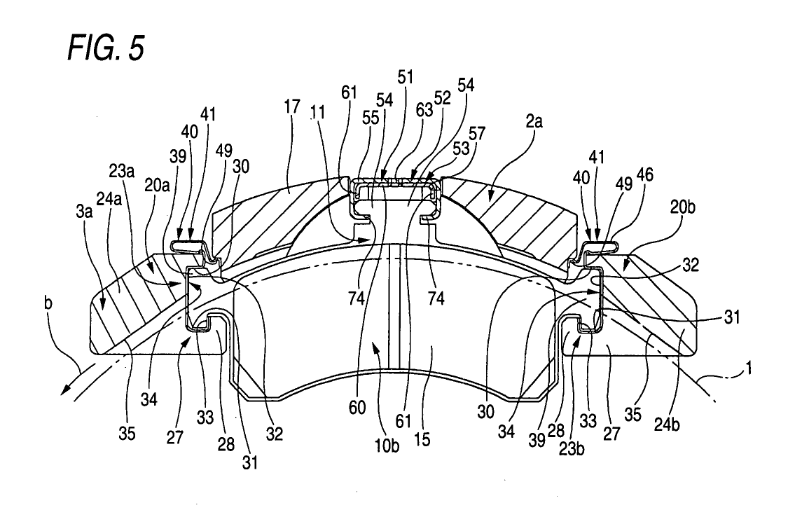

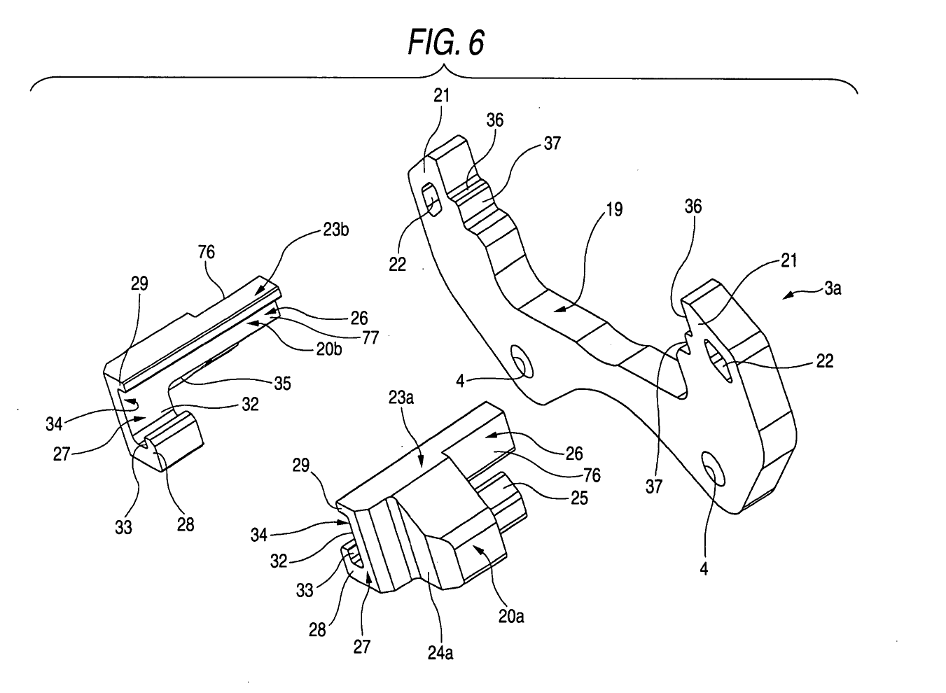

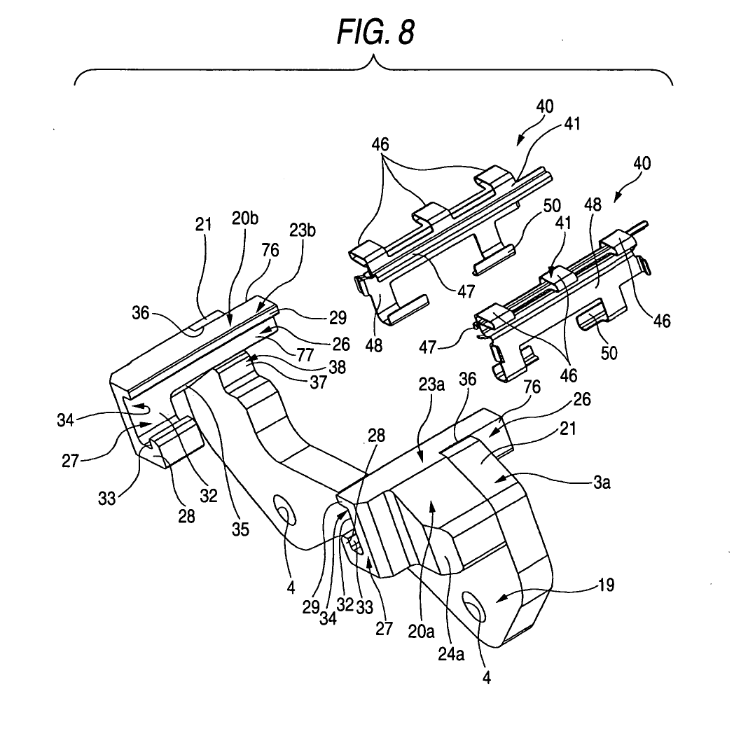

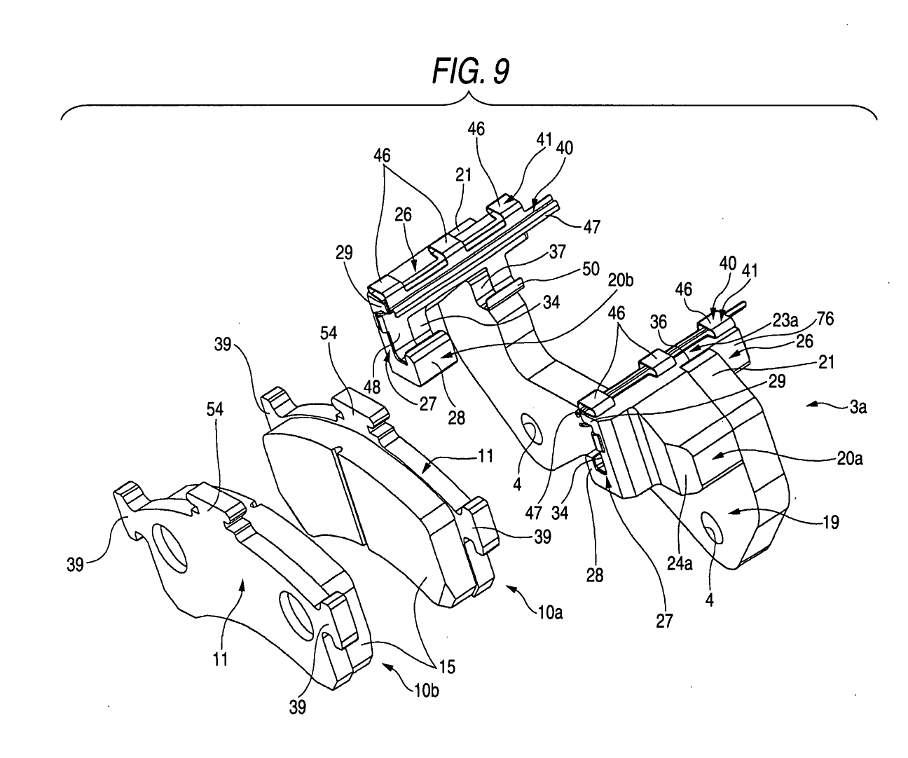

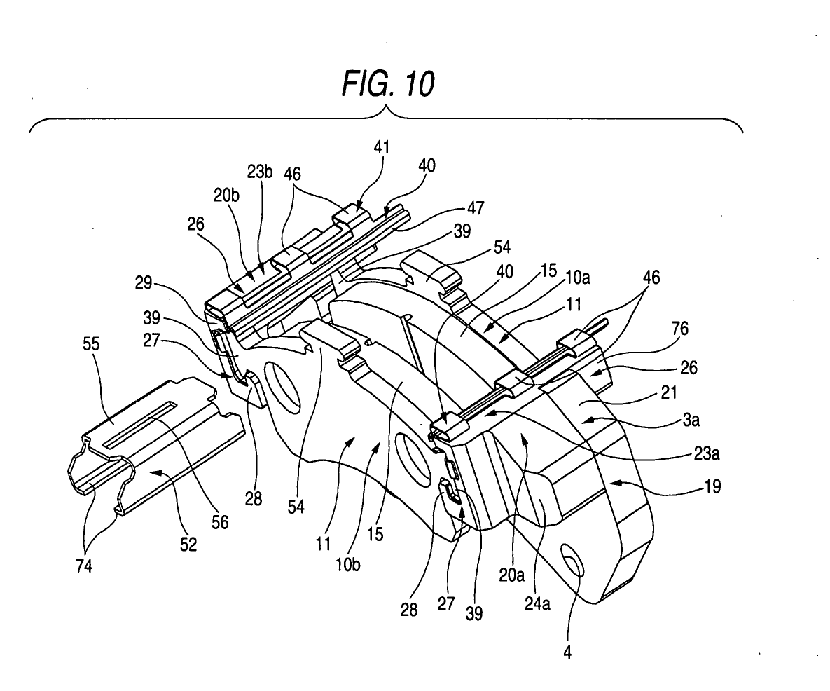

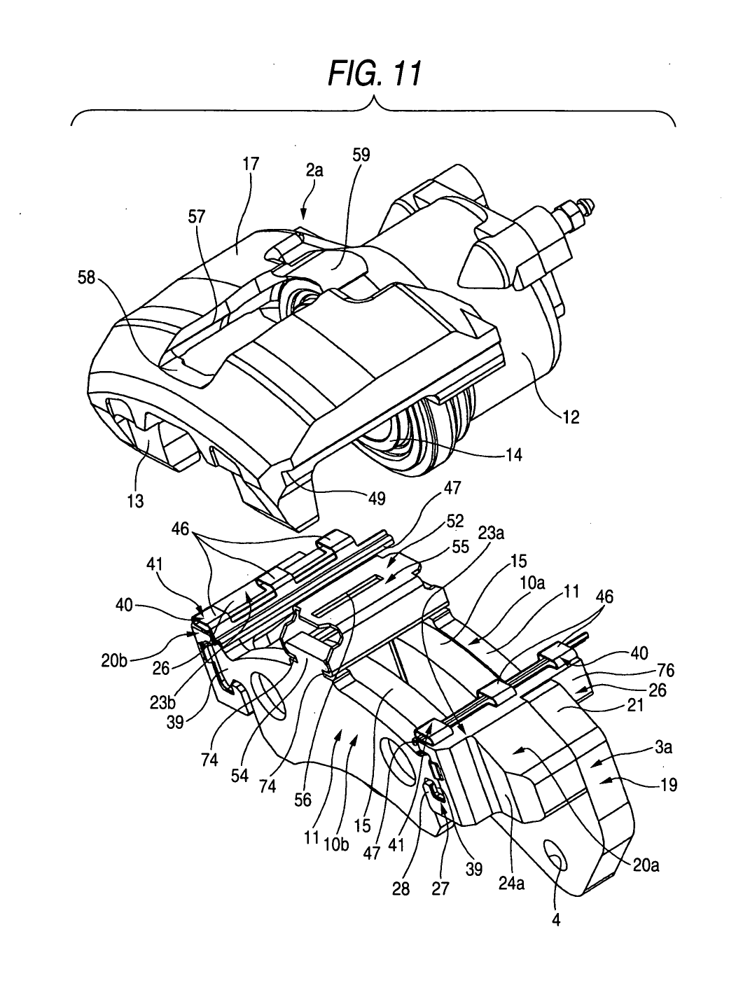

FIGS. 1 to 15 are views showing a floating caliper type disc brake according to a first exemplary embodiment of the present invention. In these views, FIGS. 1 to 5 and 13 are views showing a state of a finished product of the floating caliper type disc brake, and FIGS. 6 to 12 are views showing a state in which the floating caliper type disc brake is in the middle of assembling. The floating caliper type disc brake of the present exemplary embodiment is provided with: a support member 3a; a pair of pads 10a, 10b; and a caliper 2a. In the case, the caliper 2a includes: a claw portion 13 provided on one side of a bridge portion 17 which crosses a rotor 1 rotating together with a wheel and also crosses a pair of pads 10a, 10b; and a cylinder portion 12, which is arranged on the other side of the bridge portion 17, into which a piston 14 is incorporated. Both the pads 10a, 10b are arranged on both sides of the rotor 1 in the axial direction and guided and supported by the support member 3a so that the pads 10a, 10b can slide in the axial direction (the lateral direction of FIG. 2, the front and the reverse surface direction of FIGS. 3 to 5 and FIGS. 13 to 15) of the rotor 1.

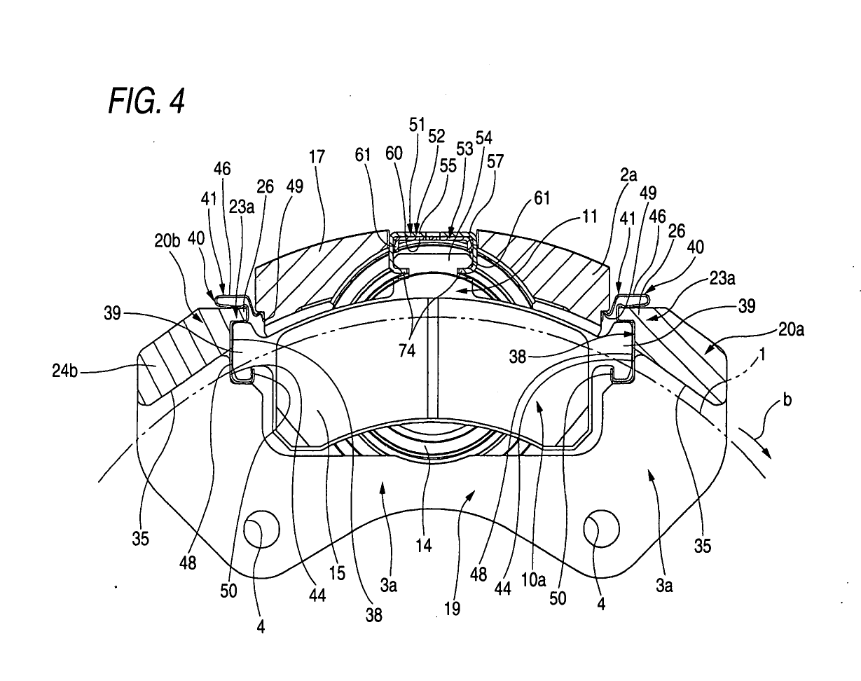

Especially, in the case of the present exemplary embodiment, the support member 3a is composed as shown in FIGS. 6 to 8 in detail. The support member 3a includes: an inner side attaching member 19 arranged at a position shifted to the inner side with respect to the rotor 1; and a pair of torque receiving members 20a, 20b which are members different from the inner side attaching member 19. In the case, the inner side is a right side of FIGS. 1, 2, 6, 8 to 12, a front surface side of FIGS. 3, 5, 7 and 13, and a reverse side of FIGS. 4, 14 and 15 on the central side in the width direction of a vehicle. Both the torque receiving members 20a, 20b are joined and fixed to both end portions in the circumferential direction of the rotor 1 of the inner side attaching member 19. In the case, the inner side attaching member 19 is formed in such a manner that a metallic plate such as a steel plate, the thickness of which is predetermined, is curved into a substantial U-shape, and a pair of attaching holes 4, 4 are formed in a lower end portion of the inner side attaching member 19 while penetrating the inner side attaching member 19 in the axial direction of the rotor 1. The inner side attaching member 19 is fixed to a vehicle body via the pair of attaching holes 4, 4 being adjacent to the rotor 1.

A pair of arm portions 21, 21 used for connection are provided at both end portions in the circumferential direction of the rotor 1 of the above inner side attaching member 19. At forward end portions of these arm portions 21, 21 used for connection, a pair of through-holes 22, 22, which are parallel with a central axis of the rotor 1, are formed. These through-holes 22, 22 are formed at positions shifted outside from an outer circumferential edge of the rotor 1 in the radial direction of the rotor 1.

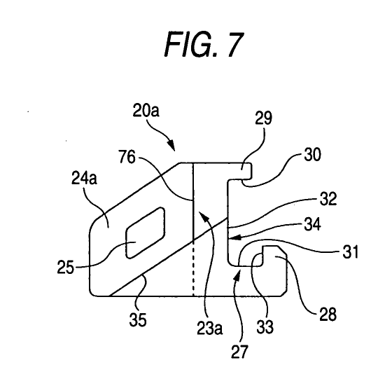

As shown in FIGS. 6 and 7 in detail, the toque receiving members 20a, 20b are made of metal such as steel. The toque receiving members 20a, 20b include: anchor portions 23a, 23b, which are long in the axial direction of the rotor 1, provided inside so that the toque receiving members 20a, 20b can be opposed to each other; and arm portions 24a, 24b integrally formed on the outside of the toque receiving members 20a, 20b on the outside of the anchor portions 23a, 23b. In the case, the axial direction of the rotor 1 is the lateral direction of FIG. 6 and the front surface and the reverse surface direction of FIG. 7. The outside of the anchor portions 23a, 23b is the left side of FIGS. 1, 2, 6, 8 to 12, the reverse side of FIGS. 3, 5, 7 and 13, and the front surface side of FIGS. 4, 14 and 15. Protrusions 25, 25 used for insertion are protruded onto the inner sides of the arm portions 24a, 24b. In the case, the inner sides of the arm portions 24a, 24b are the right side of FIG. 6 and the front sides of FIG. 7.

Each anchor portion 23a, 23b includes: a first portion 26, which is an outer end portion in the radial direction of the rotor 1, the cross-section of which is an L-shape, arranged in an upper end portion; and a second portion 27, which is an outer side end portion of the first portion 26 and on the inner end side in the radial direction of the rotor 1, protruded onto the lower end side. At a lower end portion (an inner end portion in the radial direction of the rotor 1) of the second portion 27, a drawing anchor portion 28, is provided, the cross-section of which is an L-shape, the forward end portion of which is curved outside in the radial direction of the rotor 1, and which is protruded onto the opponent torque receiving member 20b (or 20a) side. In an upper end portion of the first portion 26, an engaging protrusion 29, which is protruded to the opponent torque receiving member 20b (or 20a) side, is provided in the entire length in the longitudinal direction. Due to the above structure, inside of the outer side end portion of each torque receiving member 20a, 20b, a first recess groove 34, 34 can be formed which includes: a first and a second inner wall face 30, 31, which are separate in the radial direction of the rotor 1 and substantially parallel to each other; and a third and a fourth inner wall face 32, 33 which are separate in the circumferential direction of the rotor 1 and substantially parallel to each other. On a lower side of the inner side end portion of each arm portion 24a, 24b, a step portion 35 is formed which is used for preventing the occurrence of interference with the outer circumferential edge portion of the rotor 1.

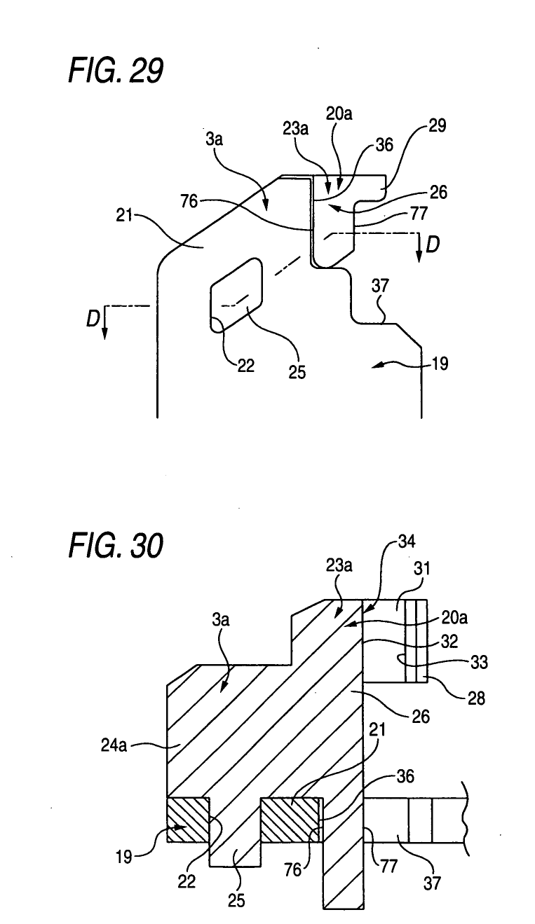

Each torque receiving member 20a, 20b composed as described above is joined to the inner side attaching member 19 as described before so as to compose the support member 3a. As shown in FIGS. 29 and 30, into each through-hole 22, 22 formed at the forward end portion of each arm portion 21, 21 used for connection of the inner side attaching member 19, the protrusion 25, 25, which is provided in each torque receiving member 20a, 20b, is inserted. (See FIGS. 2, 3, 6 and 8 about the torque receiving member.) In other words, each through-hole 22, 22 and each protrusion 25, 25 for insertion are engaged with each other by the engagement of the protrusion with the recess. At the same time, onto the inside of the step portion 36, 36, the cross-section of which is an L-shape, formed on the inner side (the face on the central side in the width direction of the inner side attaching member 19; right side surface in FIGS. 29 and 30) of the forward end portion of each arm portion 21, 21 used for connection, an inner side end portion of the anchor portion 23a, 23b (obverse side end portion in FIG. 29, lower side surface in FIG. 30) provided in each torque receiving member 20a, 20b is made to proceed. Then, an inside surface (right side surface in FIGS. 29 and 30) which is a surface of each of the step portions 36 in a vicinity of the first through-hole 22 facing center side in a width direction, and an outside surface 76 of the inner side end portion of each of the anchor portions 23a, 23b are contact with each other with a minute clearance or loosely contact. In the state, when a portion protruded from each through-hole 22, 22 than an inner side surface of the inner side attaching member 19 is expanded and caulked in the inner side end portion of the protrusion 25, 25 used for insertion, a caulked portion 65, 65 is formed, as shown in FIGS. 2 and 3. Due to the foregoing, the protrusion 25, 25 used for insertion is fixed to the inner side attaching member 19 by means of caulking, so that each of the torque receiving members 20a, 20b and the inner side attaching portion 19 are fixed. In addition, the center side surface of the step portion 36 of the inner side attaching member 19 is pushed toward the outer surface 76 of the anchor portion 23a, 23b by the caulking, so that the center side surface is firmly contact with the outer surface 76.

The caulking operation so as to fix the torque receiving member 20a, 20b and the inner side attaching member is carried out as follows. First, in a condition shown in FIGS. 29 and 30, a jig (not shown) is attached to an inner end portion of the anchor portion 23a, 23b (obverse side end portion in FIG. 29, lower side surface in FIG. 30) provided in each torque receiving member 20a, 20b, at an inside surface 77 on which pads are to be located. Then, a forming jig (not shown) is pushed to the portion protruded from the through-hole 22 of the end portion of the protrusion 25, so that the caulked portion 65 is formed (FIGS. 2 and 3). Since the caulked portion 65 is formed in this manner, a positioning accuracy of the inside surface 77 of the torque receiving member 20a, 20b, which is a surface to receive a braking torque from the pads 10a, 10b, can be improved. Moreover, a peripheral portion of the through-hole 22 is deformed to expand at the forward end portion of the arm portion 21. (The peripheral portion of the through-hole 22 is expand by the caulking, since the protrusion 25 in the through-hole 22 is expand in a radial direction of the protrusion 25 when the protrusion is pushed in an axial direction of the protrusion 25 during the caulking.) In addition to a result of attaching the jig to the inside surface 77 of the torque receiving member 20a, 20b, accordingly, the inner side surface of the step portion 36 in the vicinity of the through-hole 22, which is an inside surface deformed to spread at the forward end portion of the arm portion 21, and the outer side surface 76 of the inner end portion of the anchor portion 23a, 23b of the torque receiving portion 20a, 20b are firmly contact with each other and pushed with each other.

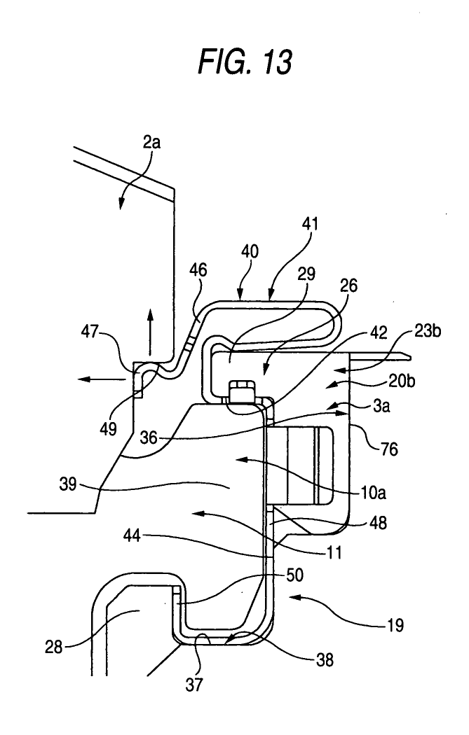

In the state, by the inner face, the cross-section of which is an L-shape, of the inner side end portion of each anchor portion 23a, 23b and by the inner side of the second step portion 37, the cross-section of which is an L-shape, continuing to a lower portion of each step portion 36 and by the upper face of the second step portion 37, a pair of the second recess grooves 38, 38 (shown in FIGS. 3 and 13), the cross-section of which is a substantial C-shape, are composed. Each second recess groove 38, 38 includes: a first inner wall face 42 located on the outer end side in the radial direction of the rotor 1; an upper face of the second step portion 37 which is a second inner wall face substantially parallel with the first inner wall face 42; and a third inner wall face 44 which is interposed between the first inner wall face 42 and an upper face of the second step portion 37. Substantially T-shaped engaging protrusions 39, 39, which are engaging portions 38, 38 provided at both end portions of the pressure plate 11 composing the inner side pad 10a, are freely engaged with the second recess grooves 38, 38.

The first recess grooves 34, 34, which are arranged in the outer side end portions of the torque receiving members 20a, 20b, are freely engaged with the substantially T-shaped engaging protrusions 39, 39 which are engagement portions provided in both end portions of the pressure plate 11 composing the outer side pad 10b. Central sides in the width direction of the pad 10b of the engagement protrusions 39, 39 provided in both end portions of the pressure plate 11 composing the outer side pad 10b are opposed to the fourth inner wall faces 33, 33 which are forward end portion inside inner faces of the drawing anchor portions 28, 28 in the circumferential direction of the rotor 1.

A pair of pad clips 40, 40 are attached to the support member 3a composed as described above in such a manner that the pair of pad clips 40, 40 cover inner faces of the first and the second recess groove 34, 38 and also cover intermediate portions formed between the recess grooves 34, 38 of the torque receiving members 20a, 20b. Each pad clip 40, 40 is integrally formed out of an elastic metallic plate such as a stainless steel plate having a high corrosion resistance. Each pad clip 40, 40 has a function of preventing the occurrence of rattling of each pad 10a, 10b with respect to the support member 3a at the time of no-braking operation. Each pad clip 40, 40 also has a function of preventing the corrosion of a sliding portion of the pressure plate 11, 11 with the support member 3a which compose each pad 10a, 10b. In an upper end portion of each pad clip 40, 40, elastic portion 41, 41 for pushing are provided. In a state in which each pad clip 40, 40 is attached to the support member 3a, a base end portion of each elastic portion 41, 41 for pushing extends upward from an upper face of each torque receiving member 20a, 20b. Each elastic portion 41, 41 includes: three leg portions capable of being pushed onto an upper face of each torque receiving member 20a, 20b; and pushing pieces 47, 47 for connecting the forward end portions of the leg members 46, 46. Each leg portion 46, 46 is connected to a base end portion in a portion which is curved to an attaching side in an upper end portion of the body portion 48, 48 of the pad clip 40, 40. In the case, the attaching side is a side on which the pad clips 40, 40 are separated from each other, that is, the attaching side is a right side in FIG. 13. Each leg portion 46, 46 is bent into a U-shape at a middle portion of a portion extending to the attaching side, and a portion close to the forward end portion extending to a side opposite to the attaching side is bent to the lower side, which is the inside in the radial direction of the rotor 1 and to the side opposite to the attaching side. In the case, the side opposite to the attaching side is a side on which the pad clips 40, 40 come close to each other, that is, the side opposite to the attaching side is a left side in FIG. 13. The pushing piece 47, 47 is a member, the cross section of which is an S-shape, which is longer than the entire length of each torque receiving member 20a, 20b. The pushing piece 47, 47 connects the forward end portions of the leg portions 46, 46.

The pad clips 40, 40 composed as described above are attached so that the pad clips 40, 40 can cover inner faces of the first and the second recess groove 34, 38 and spaces formed between the recess grooves 34, 38 of the torque receiving members 20a, 20b. In the state, a lower face of each leg portion 46, 46 of each elastic portion 41, 41 used for pushing is pushed to an upper face of each torque receiving member 20a, 20b, and a portion close to the forward end portion of each leg portion 46, 46 and the pushing piece 47 are protruded inward (to the left in FIG. 13) from the inside (the left side in FIG. 13) of the upper end portion of each torque receiving member 20a, 20b. As described later, the pushing pieces 47 are elastically pushed onto both sides in the width direction of the caliper 2a and the lower faces of the step portions 49, 49 provided on both sides while the caliper 2a is being supported by the support member 3a so that the caliper 2a can be arranged between the torque receiving members 20a, 20b.

A bent portion 50, which is bent toward the outside (the upper side) in the radial direction of the rotor 1, is provided at the forward end portion of the inner end portion (the lower end portion) in the radial direction of the rotor 1 which covers the inner face of the second recess groove 38, 38 in the inner side end portion of each pad clip 40, 40. While the pad clips 40, 40 are being attached to the support member 3a, the engaging protrusions 39, 39 provided at both end portions of the pressure plates 11, 11 of the pads 10a, 10b are freely engaged with the first and the second recess groove 34, 38 via the pad clips 40, 40 so that they can be moved in the axial direction of the rotor 1.

The support member 3a is joined and fixed to a knuckle, which composes a suspension not shown, by bolts not shown inserted into the attaching holes 4, 4 provided in the inner side attaching member 19. Due to the foregoing, the support member 3a is fixed to a vehicle body being adjacent to the rotor 1. In the state, the support member 3a is arranged in such a manner that the support member 3a crosses an outer circumferential portion of the rotor 1 in the lateral direction of FIG. 2.

The caliper 2a is supported by a holder 51, which is provided between the caliper 2a and the pads 10a, 10a, so that the caliper 2a can be moved in the axial direction with respect to the pads 10a, 10b supported by the support member 3a. The holder 51 includes: a holding member 52 formed in such a manner that a metallic plate is bent so that the cross-section can be formed into a substantial C-shape and so that both end edge portions, which are opened downward, can be bent, coming close to each other; and a lock plate 53 which is an engaging member freely inserted into the inside of the holding member 52. A protrusion 54, the cross-section of which is a substantial T-shape, which is provided in a central portion in the width direction of the pressure plate 11 composing each pad 10a, 10b, is inwardly engaged with the holding member 52 in such a manner that the protrusion 54 can be relatively moved in the axial direction of the rotor 1. In the central portion of the bottom plate portion 55 composing the holding member 52, an elliptical hole 56, the length of which is long in the axial direction of the rotor 1, is formed. By a pair of bent pieces 74, 74 which are provided in the opening edge portion of the holding member 52, a forward end portion of the protrusion 54 of each pad 10a, 10b can be prevented from coming out to the inside in the radial direction of the rotor 1 from the inside of the holding member 52.

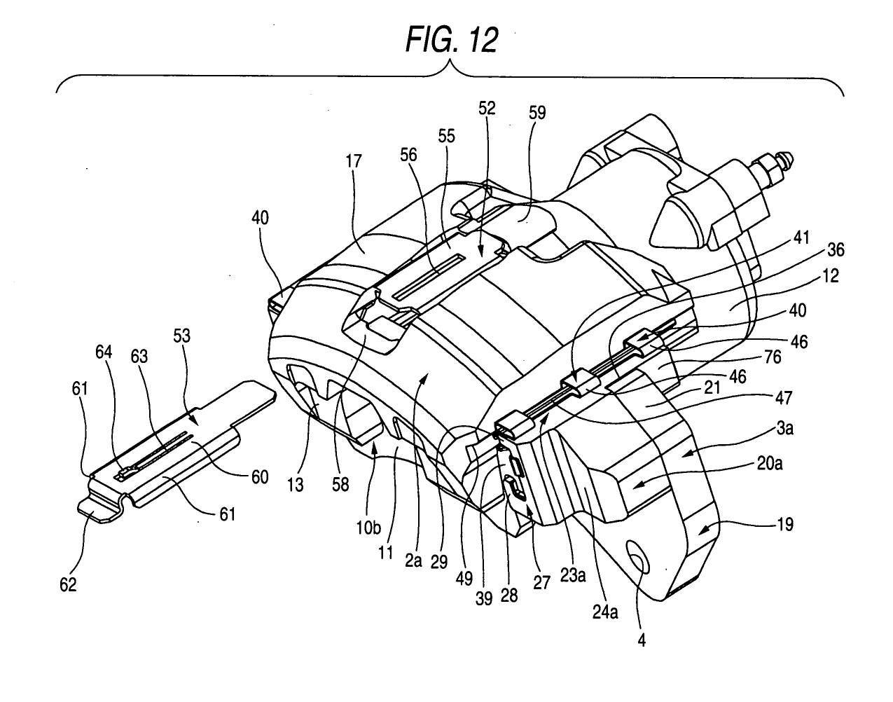

While the protrusion 54 of each pressure plate 11 is being inwardly engaged with the holding member 52, the holding member 52 is inserted into the through-hole 57, which is formed in the central portion of the bridge portion 17 of the caliper 2a, in the radial direction from the inside to the outside. A portion close to the bottom plate portion 55 of the holding member 52 is protruded from a bottom face of the groove portion 58, which is provided in opening end both side portions of the through-hole 57 on the outer face of the bridge portion 17, and from an upper face of the step portion 59. Inside the portion protruded outside the holding member 52, the lock plate 53, which is put on the outer face of the bridge portion, is inserted in the axial direction of the rotor 1. The lock plate 53 includes: a main body portion 60 made of metal, the detail of which is shown in FIG. 12; a pair of arm portions 61 formed by bending in a portion (a portion close to the left end of FIG. 12) close to one end in the longitudinal direction of both side edges in the width direction of the main body portion 60; and a bent piece 62, the cross-section of which is an L-shape, provided on end edge (the left end edge of FIG. 12) in the longitudinal direction of the main body portion 60. When a forward end portion of the inside portion of the C-shaped cutout 63, which is long in the axial direction of the rotor 1, formed in the central portion of the main body portion 60 is bent outside in the radial direction of the rotor 1, the engaging protrusion 64 is provided.

Inside of a portion close to the bottom plate portion 55 of the holding member 52 protruded from the bottom face of the groove portion 58 of the outer face of the bridge portion 17 and from the upper face of the step portion 59, the lock plate 53 is inserted in the axial direction of the rotor 1 (in the lateral direction of FIG. 12). In the state, both end portions in the longitudinal direction of the lock plate 53 is provided between the bottom face of the groove portion 58 and the upper face of the step portion 59. That is, the lower face of the forward end portion of the main body portion 60 and the upper face of the step portion 59 are contacted with each other, and the bent piece 62 is contacted with the bottom face of the groove portion 58. Due to the above structure, the lock plate 53 can be restricted from moving inward in the radial direction of the rotor 1 with respect to the caliper 2a. At the same time, the lock plate 53 can be engaged with the holding portion 52.

Further, when the engaging protrusion 64 formed on the lock plate 53 is engaged with the elliptical hole 56 formed in the holding member 52, the lock plate 53 can be prevented from carelessly coming out in the axial direction of the rotor 1 from the inside of the holding member 52. In the case where the lock plate 53 is taken out from the inside of the holding member 52, a forward end portion of the engaging protrusion 64 of the lock plate 53 is elastically deformed inside in the radial direction of the rotor 1, and under the condition that the forward end portion is made to come out from the elliptical hole 56, the lock plate 53 is drawn out in the axial direction of the rotor 1 from the inside of the holding member 52. When the lock plate 53 is drawn out from the holding member 52, the caliper 2a can be detached to the outside (to the upper side on FIG. 12) in the radial direction of the rotor 1 with respect to the support member 3a. As described above, the caliper 2a can be moved in the axial direction of the rotor 1 with respect to the pads 10a, 10b by the holder 51 including the holding member 52 and the lock plate 53 and supported by the pads 10a, 10b being capable of engaging with and disengaging from the support member 3a.

In the state, a portion close to the forward end portion of the pushing piece 47 provided at the forward end portion of the pad clip 40, 40 attached to the support member 3a is elastically pushed to the outside in the radial direction of the rotor 1 onto the lower face of the step portion 49 provided on both sides in the width direction of the caliper 2a. Further, the portion close to the forward end portion of the pushing piece 47 is elastically pushed in the circumferential direction onto the side in the circumferential direction of the rotor 1 of the caliper 2a. Due to the above structure, the pushing piece 47 gives an elastic force, which is directed upward and in the circumferential direction of the rotor 1, to the caliper 2a. As a result, the caliper 2a is elastically raised to the outside in the radial direction of the rotor 1 with respect to the support member 3a. At the same time, the caliper 2a is restricted from being displaced in the radial direction of the rotor 1 by the engagement of the lock plate 53 with the holding member 52 and by the engagement of the holding member 52 with the protrusion 54 provided in the central portion in the width direction of the pressure plate 11. In the state, an upper side of each protruding protrusion 39, 39 provided in both end portions of the pressure plate 11 of each pad 10a, 10b is elastically pushed onto the first inner wall face 30, 42 of the first and the second recess groove 34, 38 via the pad clip 40, 40. Therefore, the pad 10a, 10b can be moved in the axial direction of the rotor 1 with respect to the support member 3a. In the state, a small gap is formed among the inner side (the lower side) in the radial direction of the rotor 1 of the engaging protrusion 39, 39 provided on the pressure plate 11 of the pad 10a, 10b, the second inner wall face 31 composing the first recess groove 34 and the upper side of the pad clip 40, 40 which covers an upper face of the second step portion 37 composing the second recess groove 38. Due to the above structure, the caliper 3a can be supported being capable of moving in the axial direction of the rotor 1 with respect to the support member 3a and the pad 10a, 10b without generating rattling of the caliper 3a.

In the floating caliper type disc brake of the exemplary embodiment composed as described above, the inner side attaching member 19 can be formed in a flat (having constant shape in the axial direction of the rotor) and simple shape, and the torque receiving members 20a, 20b also can be formed in a simple shapes. Accordingly, it is easy to carry out the machining process to the fixing portion of the torque receiving member 20a, 20b fixed to the inner side attaching member 19 and the portion for receiving the braking torque from the pads 10a, 10b of the torque receiving member 20a, 20b. In addition, the torque receiving member 20a, 20b can be formed to be a small part, the torque receiving member 20a, 20b can be formed by a forging process. When the torque receiving member 20a, 20b is formed by the forging process, the manufacturing cost become lower than the case that the torque receiving member 20a, 20b is formed by a cutting process to a material for the torque receiving member 20a, 20b. As a result, a total manufacturing cost of the disc brake can be reduced.

In addition, in accordance with the present exemplary embodiment, the torque receiving members 20a, 20b and the inner side attaching member 19 are fixed by caulking a portion of the torque receiving member 20a, 20b protruded from the through-hole 22 of the inner side attaching member 19 at a forward end portion of the protrusion 25. Therefore, it is not needed to use a bolt or welding means so as to fasten the inner side attaching member 19 and the torque receiving members 20a, 20b. As a result, the inner side attaching member 19 and the torque receiving members 20a, 20b can be fastened in a short time and low cost, so that the total manufacturing cost of the disc brake is reduced.

Moreover, in the peripheral portion of the through-hole 22 of the inner side attaching member 19, since the peripheral portion is deformed to spread by the caulking process, the center side surface in the width direction in the vicinity of the through-hole 22 (inner side surface of the step portion 36) is firmly contact with the outer surface 76 of the torque receiving member 20a, 20b at inner side end, so that the inner side attaching member 19 and the torque receiving member 20a, 20b are pushed with each other. Therefore, at least a part of braking torque applied to the pad 10a, 10b during braking is transmitted to the inner side attaching member 19, via a contact portion between the center side surface in the width direction in the vicinity of the through-hole (the inner side surface of the step portion 36) and the outer surface 76 of the torque receiving portion 20a, 20b at the inner side end, without transmitted through the protrusion 25 of the torque receiving member 20a, 20b. As a result, a stress applied to a caulked portion 65 of the protrusion 25 during braking is reduced, so that a strength of the support member 3a can be held enough and the durability of the support member 3a can be improved.

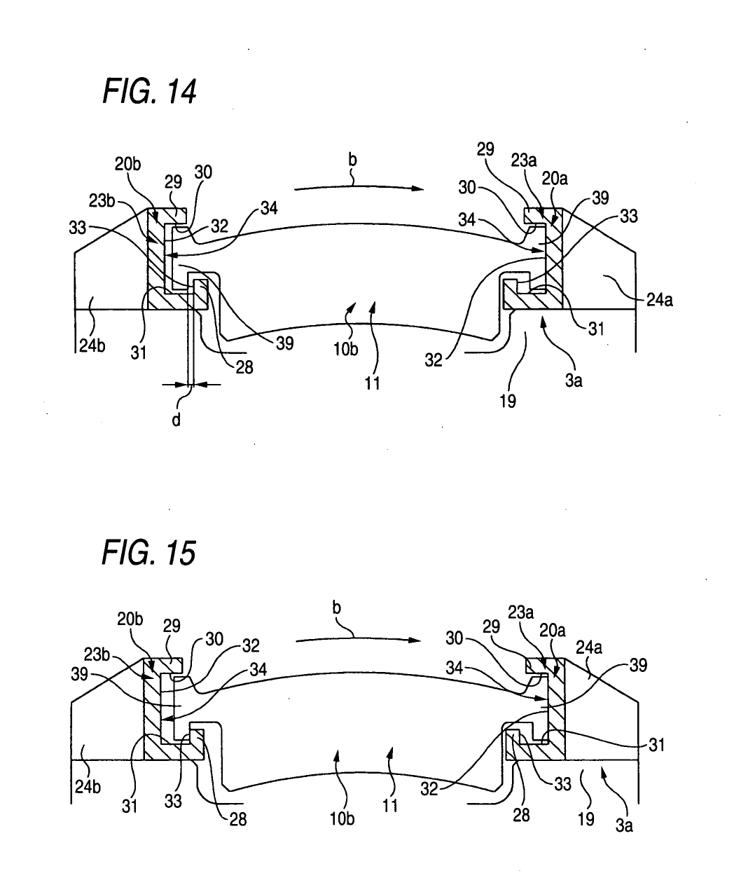

Moreover, in the floating caliper type disc brake of the exemplary embodiment composed as described above, at the time of applying the brakes, the braking torque given to the outer side pad 10b from the rotor 1 is received by the support member 3a via the torque receiving member 20a on the delivery rotation side which is the front side of the rotary direction (the direction shown by arrow “b” in FIGS. 1 to 5, 14 and 15) of the rotor 1 when the vehicle is running forward. Further, the braking torque can be also received by the torque receiving member 20b on the entry rotation side which is the rear side in the rotary direction of the rotor 1. That is, while the vehicle is running forward, when the pads 10a, 10b are pushed onto both sides of the rotor 1 so as to conduct braking operation, the pads 10a, 10b are moved in the rotary direction of the rotor 1. In the case where an intensity of the braking torque is relatively low, as briefly shown in FIG. 14, a front side in the rotary direction of the rotor 1 of the engaging protrusion 39 provided in the other end portion (the left end portion of FIG. 3 and the right end portion of FIGS. 4 and 14) of the pressure plate 11 of the pad 10a, 10b is pushed onto the third inner wall face 32, 44 (Concerning the third inner wall face 44, refer FIGS. 3, 4 and 13.) which is a front side in the rotary direction of the rotor 1 of the first and the second recess groove 34, 38 (Concerning the second recess groove 38, refer to FIGS. 3, 4 and 13.) of the torque receiving member 20a on the delivery rotation side. The receiving torque is received by the support member 3a only by the torque receiving member 20a on the delivery rotation side in the torque receiving members 20a, 20b on the entry rotation side and the delivery rotation side. In the case, a small gap “d” is formed between the front side in the rotary direction of the rotor 1 of the engaging protrusion 39 provided in one end portion (the left end portion of FIG. 14) of the pressure plate 11 composing the outer side pad 10b and the fourth inner wall face 33 which is an inner face of the drawing anchor portion 28 provided in the torque receiving member 20b on the entry rotation side.

On the other hand, when an intensity of the braking torque is relatively high, as briefly shown in FIG. 15, a front side in the rotary direction of the rotor of the engaging protrusion 39 provided in the other end portion (the left end portion of FIG. 3, the right end portion of FIGS. 4 and 15) of the pressure plate 11 of the pad 10a, 10b is strongly pushed onto the third inner wall face 32, 44 (Concerning the third inner wall 44, refer to FIGS. 3, 4 and 13.) of the first and the second recess groove 34, 38 (Concerning the second recess groove 38, refer to FIGS. 3, 4 and 13.) provided in the torque receiving portion 20a on the delivery rotation side. As a result, the delivery rotation side portion of the support member 3a is greatly deformed, and the pad 10a, 10b is greatly moved to the front side in the rotary direction of the rotor 1. As a result, a front side in the rotary direction of the rotor of the engaging protrusion 39 provided in one end portion (the left end portion of FIG. 15) of the pressure plate 11 composing the outer side pad 10b is pushed onto the fourth inner wall face 33 which is an inner face of the forward end portion of the drawing anchor portion 28 provided in the torque receiving member 20b on the entry rotation side. The braking torque is received by the delivery rotation side torque receiving member 20a in the entry rotation side and the delivery rotation side torque receiving member 20a, 20b. Further, the braking torque can be also received by the support member 3a in the drawing anchor portion 28 of the entry rotation side torque receiving member 20b.

As a result, the braking torque can be supported being shared by both the torque receiving members 20a, 20b on the delivery rotation side and the entry rotation side. Accordingly, it is possible to prevent an excessively high braking torque from being concentrated upon a portion of the support member 3a. Therefore, the support member 3a can be sufficiently prevented from being deformed. Further, even when a reinforcing portion for connecting the outer side portions of the torque receiving members 20a, 20b is not provided like in the present embodiment, it is possible to suppress the generation of deformation of the support member 3a. Therefore, while the support member 3a is being prevented from being deformed, the weight can be decreased.

Further, the support member 3a includes: an inner side attaching member 19 which is arranged at a position shifted to the inner side with respect to the rotor 1; and a pair of torque receiving members 20a, 20b joined to both end portions in the circumferential direction of the rotor 1 of the inner side attaching member 19. The drawing anchor portions 28, 28 are respectively arranged at the outer side end portions of the torque receiving members 20a, 20b. Therefore, the size of each torque receiving member 20a, 20b can be reduced. Therefore, although a profile of the torque receiving member 20a, 20b becomes complicated because it has a drawing anchor position 28, 28, the drawing anchor portion 28, 28 can be easily formed by the modified forming such as drawing or extrusion. On the other hand, in the case of forming a drawing anchor portion in a portion of an integrated large support, it is necessary to form the drawing anchor portion by means of cutting. Therefore, it takes time to conduct machining. Further, it is necessary to put an edge of a cutting tool into a small space, that is, the machining work becomes very difficult. However, in the present exemplary embodiment, it is possible to solve the above problems. As a result, according to the present exemplary embodiment, it is possible to sufficiently prevent the occurrence of deformation of the support member at the time of braking operation by an inexpensive and light structure.

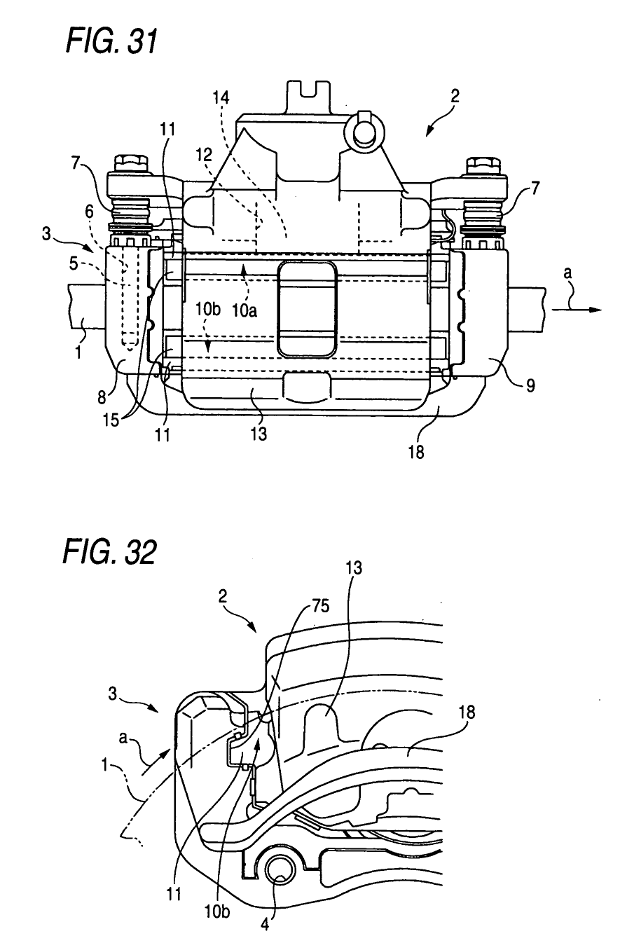

Moreover, in the present exemplary embodiment, by the holder 51 including the holding member 52, which is provided between the caliper 2a and a pair of pads 10a, 10b, and the lock plate 53, while the caliper 2a is being capable of moving in the axial direction of the rotor 1 with respect to the pads 10a, 10b, the caliper 2a supports the pad 10a, 10b being capable of engaging with and disengaging from the support member 3a. According to the present exemplary embodiment, since each pad 10a, 10b is supported by the support member 3a, being different from the conventional structure shown in FIGS. 31 and 32 described before, the caliper can be moved in the axial direction with respect to the support. Therefore, it becomes unnecessary to adopt a structure in which a guide pin joined to the caliper is slid in a guide hole formed in the support. Therefore, it is unnecessary to use a bolt for joining the guide pin to the caliper. Further, it is unnecessary to form a through-hole for inserting the bolt into the caliper. Furthermore, it is unnecessary to form the guide hole in the support. Accordingly, it is possible to provide a lighter and more inexpensive structure.

In the case of the present exemplary embodiment, the holding member 52 is prevented from moving outside in the radial direction of the rotor 1 by the engagement with a pair of pads 10a, 10b. At the same time, the lock plate 53 is engaged with a portion close to the bottom plate portion 55 of the holding member 52 inserted into the through-hole 57 which penetrates the bridge portion 17 of the caliper 2a in the radial direction of the rotor 1, so that the caliper 2a can be prevented from moving in the radial direction of the rotor 1. Accordingly, it is unnecessary to form a hole portion for inserting a guide pin in the caliper 2a and the pad 10a, 10b so as to guide the caliper 2a in the axial direction of the rotor 1 with respect to the pad 10a, 10b. Accordingly, the manufacturing cost can be more easily reduced.

Further, in the present exemplary embodiment, in the outer side end portion of the torque receiving member 20a, 20b, the anchor portion 23a, 23b having the drawing anchor portion 28, 28 is provided. In the outer side end portion of the anchor portion 23a, 23b, the first and the second inner wall face 30, 31, which are separate from each other in the radial direction of the rotor 1, and the first recess groove 34 having the third and the fourth inner wall face 32, 33, which are separate from each other in the circumferential direction of the rotor 1, are provided. Further, the first recess groove 34 and the engaging protrusions 39, 39, which are provided at both end portions of the pressure plate 11 composing the outer side pads 10a, 10b, can be engaged with each other. Therefore, in the case of the present exemplary embodiment, a profile of the anchor portion 23a, 23b having the drawing anchor portion 28, 28 becomes complicated. Accordingly, when the support member 3a includes an inner side attaching member 19 arranged at a position shifted to the inner side with respect to the rotor 1 and also includes a pair of torque receiving members 20a, 20b connected to both end portions in the circumferential direction of the rotor 1 of the inner side attaching member 19, the torque receiving member 20a, 20b having the above anchor portion 23a, 23b can be easily machined and the manufacturing cost can be reduced. Further, the first recess grooves 34, 34 have a first to a fourth inner wall face 30 to 33, and the inside of the first recess grooves 34, 34 can be engaged with the engaging protrusions 39, 39 of the outer side pads 10a, 10b. Accordingly, these engaging portions 39, 39 are not disengaged from the first recess grooves 34, 34, there is no possibility that and the outer side pad 10b carelessly falls off by the deformation of the device.

In the present exemplary embodiment, the drawing anchor portion 28, 28 is arranged only on the outer side with respect to the rotor 1 in the torque receiving member 20a, 20b. Therefore, the torque receiving member 20a, 20b can be easily formed by means of header working. On the other hand, being different from the present exemplary embodiment, in the case where a pair of the drawing anchor portions are arranged on both the outer side and the inner side with respect to the torque receiving members 20a, 20b, it is necessary to provide a recess portion, which is recessed so that the recess portion can cross the rotor 1, between both the drawing anchor portions. In the case, it is difficult to push a punch to a material, which composes the torque receiving member 20a, 20b, from the side of a portion which becomes the drawing anchor portion. Therefore, it is impossible to form the torque receiving member 20a, 20b by means of header working. However, according to the structure of the present exemplary embodiment, it is sufficient that the drawing anchor portion 28, 28 is provided only in one portion of the torque receiving member 20a, 20b. Therefore, it becomes unnecessary to provide a recess portion which is recessed in such a manner that the recess portion crosses the rotor. Therefore, the torque receiving member 20a, 20b can be easily formed by means of header working.

In the case where braking torque is given to the torque receiving member 20a, 20b from each pad 10a, 10b, with respect to the torque receiving member 20a, 20b, a distance from the outer side pad 10b to the attaching portion of the inner side attaching member 19, which is used as a fulcrum, is so long that a high intensity of moment is given to the outer side. Further, when a reinforcing portion for connecting the outer side portions is eliminated, a displacement on the outer side is larger than a displacement on the inner side. According to the structure described in the present exemplary embodiment, in the case where the drawing anchor portion 28, 28 is arranged only on the outer side, on the outer side, the braking torque can be received by both the entry rotation side torque receiving member and the delivery rotation side torque receiving member being shared. Therefore, the support member 3a can be more effectively prevented from being deformed. On the other hand, being different from the present exemplary embodiment, in the case where the drawing anchor is provided only on the inner side of both the inner and the outer side of the torque receiving member 20a, 20b and the braking toque is received only on the inner side by both the entry rotation side and the delivery rotation side torque receiving member 20a, 20b being shared, a distance between a point of application of the force given from the inner side pad 10a to the torque receiving member 20a, 20b and the attaching portion of the inner side attaching member 19 is small and the moment acting on the inner side is low. Therefore, even when the moment is received being shared, the obtained effect is low, that is, it is impossible to provide a sufficiently high effect for suppressing a displacement in the outer side portion of the support member 3a. For the above reasons, it is difficult to effectively suppress a deformation of the support. According to the structure described in the exemplary embodiment, it is possible to solve the above problems and the deformation of the support member 3a can be effectively suppressed.

In the case of the present exemplary embodiment, under the condition that each torque receiving member 20a, 20b is covered, the caliper 2a is given an elastic force in the outer radial direction and in the circumferential direction of the rotor 1 by a pad clip 40, 40 attached to the torque receiving member 20a, 20a. According to the structure, the pad clip 40, 40 having a function of suppressing the generation of rattling of each pad 10a, 10b with respect to the support member 3a can suppress rattling of the caliper 2a. Therefore, it is unnecessary that another member, which is different from the pad clip 40, 40, such as a hold spring is provided in order to suppress the generation of rattling of the caliper 2a. Accordingly, the number of parts can be decreased. By the same method as that conventionally used, the pad clip 40, 40 can be easily attached to the support member 3a before the caliper 2a is incorporated into the support member 3a. In the case where the caliper 2a is incorporated into the support member 3a, the caliper 2a may be incorporated into the support member 3a while the caliper 2a is being pushed to the pad clip 40, 40, resisting an elastic force. The caliper is put on upper faces of both end portions in the circumferential direction of the rotor, so that an elastic force can be given outward in the radial direction of the caliper. Therefore, unlike a hold spring, it is unnecessary to give a special consideration of holding it with a hand so that it cannot fall off. Accordingly, it is possible to enhance the assembling property.

In the case of the present exemplary embodiment, the torque receiving member 20a, 20b and the inner side attaching member 19 are caulked and fixed under the condition that the protrusion 25, 25 for insertion and the through-hole 22, 22 are engaged with each other by the engagement of a protrusion and a recess portion. Therefore, it is unnecessary to use a fastening member such as a screw. Further, it is unnecessary to use a joining means such as welding. Accordingly, it is possible to join the torque receiving member 20a, 20a to the inner side attaching member 19 in a short period of time at a low manufacturing cost.

In the case, the caulking work can be conducted while a jig is being made to collide with the inner side end portion of the torque receiving member 20a, 20a from a side on which the pad 10a, 10b is arranged. In the case, while the positioning accuracy of the face, on which the braking torque is received from the pad 10a, 10b, in the torque receiving member 20a, 20b is being ensured, an inner side of the forward end portion of the arm portion 21, 21 for joining of the inner side attaching member 19 and an outer side of the inner side end portion of the torque receiving member 20a, 20b can be closely contacted with each other. That is, according to the caulking work, a periphery of the through-hole 22, 22 is deformed being expanded at the forward end portion of the arm portion 21, 21 for joining. On the other hand, when the jig is made to collide with the side of the torque receiving member 20a, 20a on which the pad 10a, 10a is arranged, the face of the torque receiving member 20a, 20a, which receives torque from the pad 10a, 10a, can be positioned with high accuracy. Further, an inner side of the portion deformed being expanded at the forward end portion of the arm portion 10a, 20a for connection and an outer side of the inner side end portion of the torque receiving member 20a, 20b come close contact with and push each other. Therefore, at least a portion of the braking torque, which is given to the pad 10a, 10b at the time of braking operation, is transmitted from the anchor portion 23a, 23b of the torque receiving member 20a, 20b to the inner side attaching member 19 via a contact portion of the forward end portion inner side of the arm portion 21, 21 for connection with the outer side of the torque receiving member 20a, 20b without via the arm portion 24a, 24b of the torque receiving member 20a, 20b and the insertion protrusion 25, 25. As a result, it is possible to reduce a load given to the caulking portion 65, 65 of the protrusion 25, 25 for insertion at the time of braking operation, and the durability of the support member 3a can be enhanced.

### Second Exemplary Embodiment

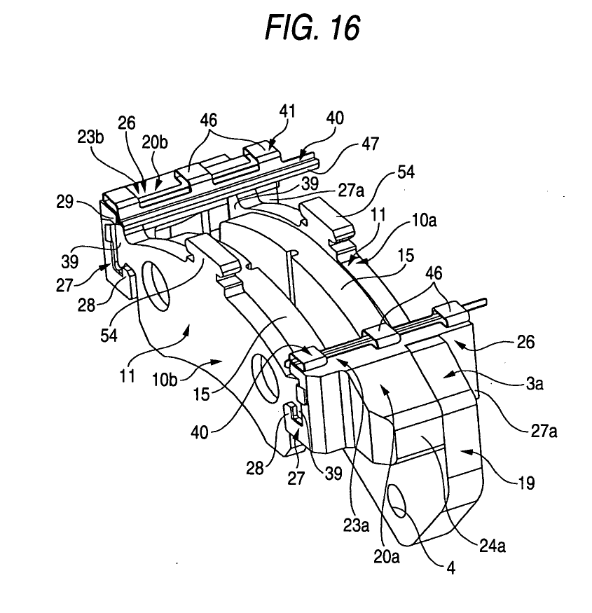

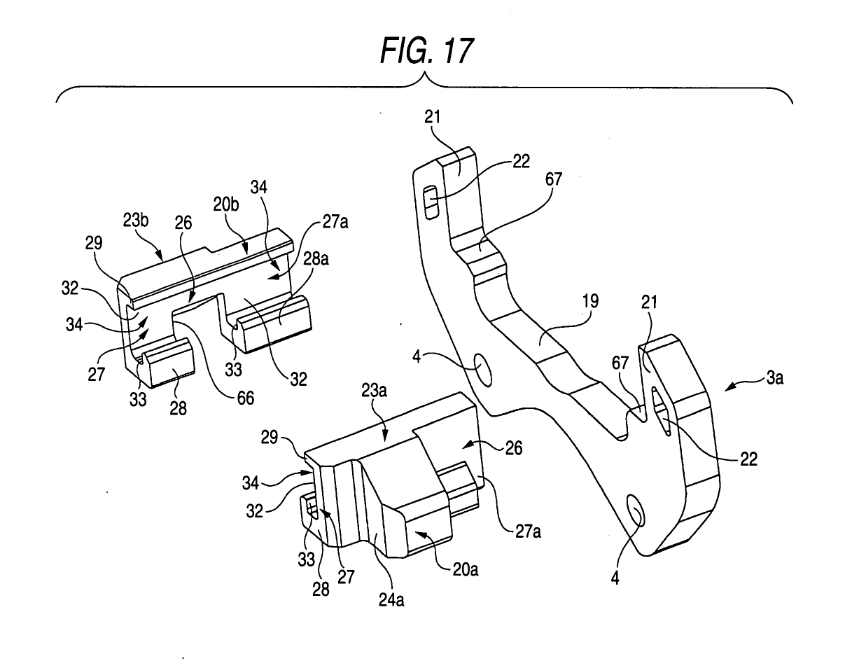

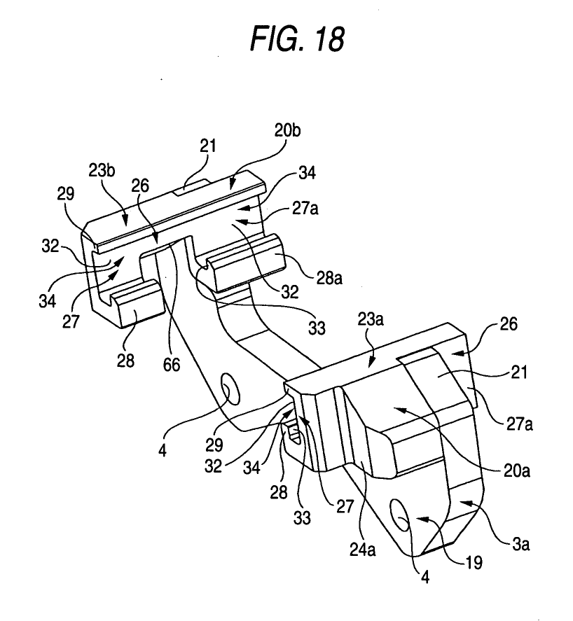

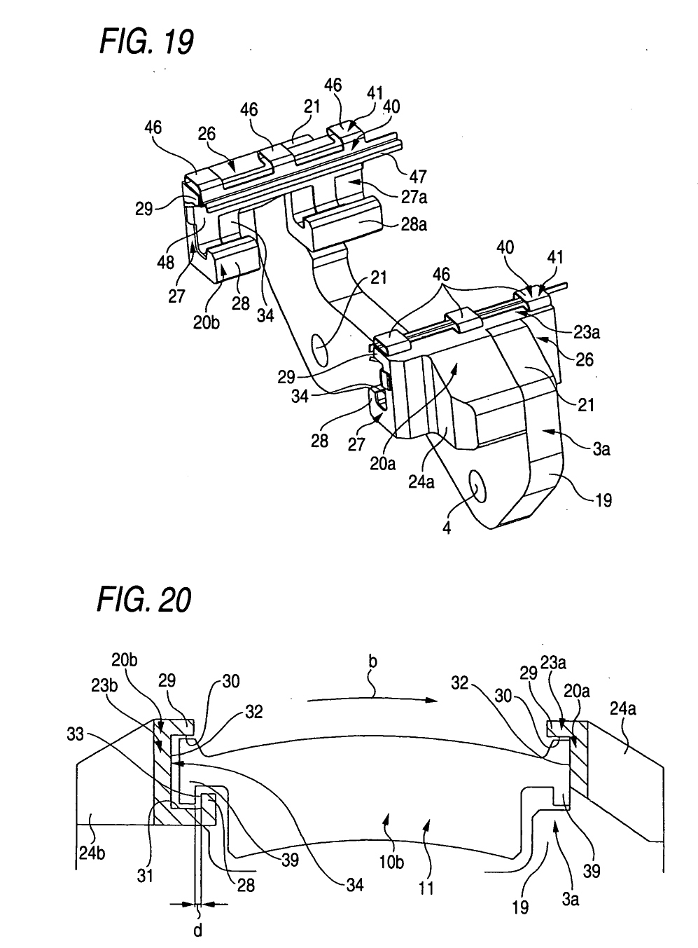

Next, FIGS. 16 to 19 are views showing a floating caliper type disc brake according to a second exemplary embodiment of the present invention. In the case of the present exemplary embodiment, substantially the same drawing anchor portion 28a as the anchor portion 28, which is provided in the outer side end portion (the left end portion of FIGS. 16 to 19), is provided in the inner side end portion (the right end portion shown in FIGS. 16 to 19) of the torque receiving member 20a, 20b. In the case, the drawing anchor portion provided in the torque receiving member 20a is omitted in the drawing. Therefore, in the case of the present exemplary embodiment, the second portion 27a, 27a protruding downward is provided in the inner side end portion of the first portion 26, 26 of the anchor portion 23a, 23a composing the torque receiving member 20a, 20b. At a lower end portion of the second portion 27a, 27a, an anchor portion 28a, the cross-section of which is formed into an L-shape in which the forward end portion is bent upward, is provided in the lower end portion of the second portion 27a, 27a. Engaging protrusions 39, which are provided at both end portions of the pressure plate 11 composing the inner side pad 10a, are freely engaged with the forward end portions of the drawing anchor portions 28a. Since the drawing anchor portion 28a is provided on the inner side of the torque receiving member 20a, 20b, in order to arrange the drawing anchor portion 28a inside of the inner side attaching member 19, a step portion 67, 67 is provided on the inner side close to the base end of the arm portion 21, 21 for joining of the inner side attaching member 19. Under the condition that the torque receiving members 20a, 20b are joined to both end portions of the inner side attaching member 19, a lower face of the drawing anchor portion 28a on the inner side collides with an upper face of the step portion 67, 67.

In the case of the present exemplary embodiment, being different from the first exemplary embodiment described before, the drawing anchor portion 28a is provided in the inner side end portion of the torque receiving member 20a, 20b, too. Therefore, a recess portion 66, which is recessed in such a manner that the recess portion 66 crosses the rotor 1 (shown in FIG. 2), is formed between both the anchor portions 28a of the torque receiving member 20a, 20a. Therefore, header working of the torque receiving member 20a, 20a becomes more difficult than that in the case of the first exemplary embodiment. However, in the case of the present exemplary embodiment, a portion of the braking torque, which is given from the pad 10a on the inner side to the support member 3a, can be received by the drawing anchor portion 28a on the inner side. Therefore, the braking torque, which is received by the torque receiving member 20a (or 20b) on the delivery rotation side which is a front side in the rotary direction of the rotor 1, can be more diffused, and the support member 3a can be less deformed than the case of the first exemplary embodiment. Even in the case where the torque receiving member 20a, 20b can not be made by means of header working, since a size of the torque receiving member 20a, 20b is small, each portion can be made by means of cutting more easily than a case in which the drawing anchor portion is provided by means of cutting work conducted on a portion of a large support member which is integrally formed.

At the time of braking operation in which a relatively high intensity of braking torque is given to the pad 10a on the inner side, a portion of the braking torque is received by the drawing anchor portion 28a on the inner side of the torque receiving member 20b (or 20a) on the entry rotation side which is a rear side in the rotary direction of the rotor 1. The action is the same as the case in which a portion of the braking torque is received by the drawing anchor portion 28 on the outer side which is explained in the first exemplary embodiment before.

The other structure and action are substantially the same as those of the first exemplary embodiment described before. Therefore, like reference characters are used to indicate like parts and the duplicate explanations are omitted here.

### Third Exemplary Embodiment

FIG. 20 is a view showing a floating caliper type disc brake according to a third exemplary embodiment of the present invention. The present exemplary embodiment is different from the first and second embodiments at the following points. In the third exemplary embodiment, the drawing anchor portion 28 is arranged only in the outer side end portion of the torque receiving member 20b on the entry rotation side which becomes a rear side in the rotary direction (the direction shown by the arrow “b” in FIG. 20) of the rotor (shown in FIG. 2) when a vehicle is running forward. No drawing anchor portion is provided in both the inner and the outer end portion of the torque receiving member 20a on the delivery rotation side which becomes a front side in the rotary direction of the rotor 1 when the vehicle is running forward.

In the case of the present exemplary embodiment, it is sufficient that only one drawing anchor portion 28 is provided in the support member 3a. Therefore, the torque receiving member 20a can be more easily manufactured. In the connection, being different from the case of the present exemplary embodiment, in the case where the drawing anchor portion is arranged on the delivery rotation side, which is a front side in the rotary direction of the rotor 1 when the vehicle is running forward, in the support member 3a, the drawing anchor portion receives the braking torque only at the time of applying the brakes when the vehicle is going back. Therefore, the frequency is low. Further, when the vehicle is going back, an intensity of the braking torque is usually low. For the above reasons, an influence, which is produced when no drawing anchor portion is provided on the delivery rotation side of the support member 3a when the vehicle is running forward, is practically small.

The other structure and action are substantially the same as those of the first exemplary embodiment shown in FIGS. 1 to 15. Therefore, like reference characters are used to indicate like parts and the duplicate explanations are omitted here.

### Fourth Exemplary Embodiment

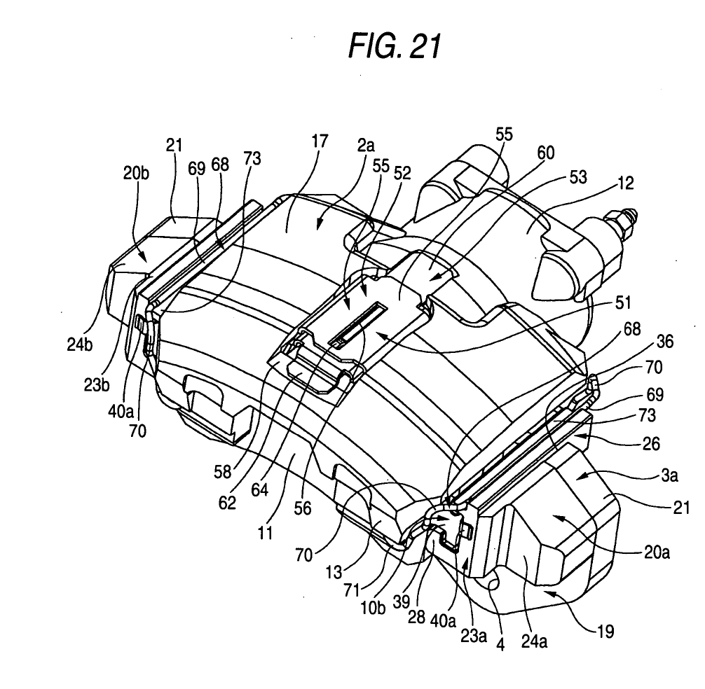

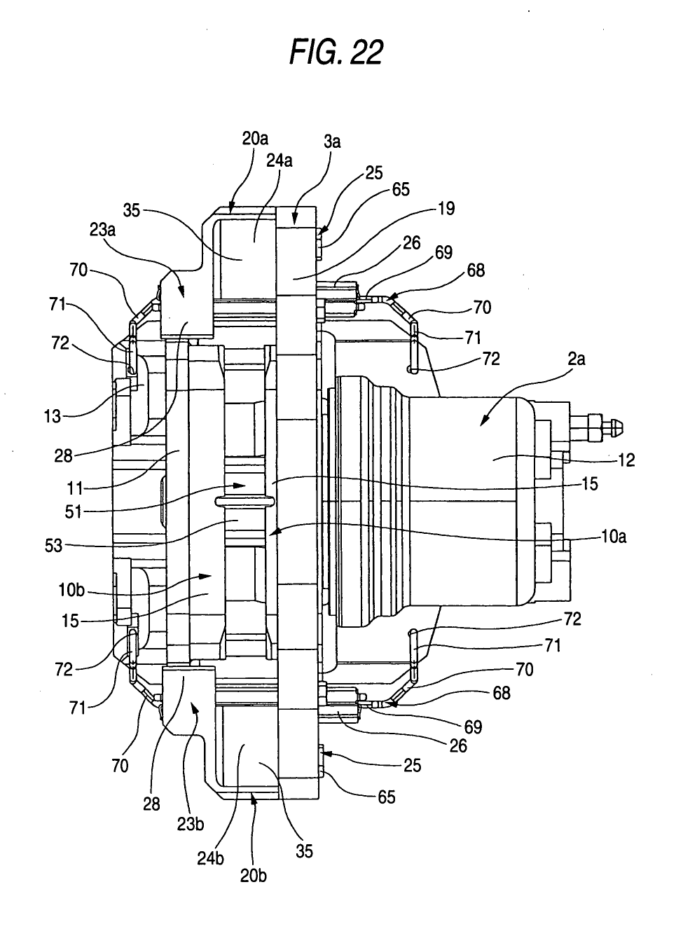

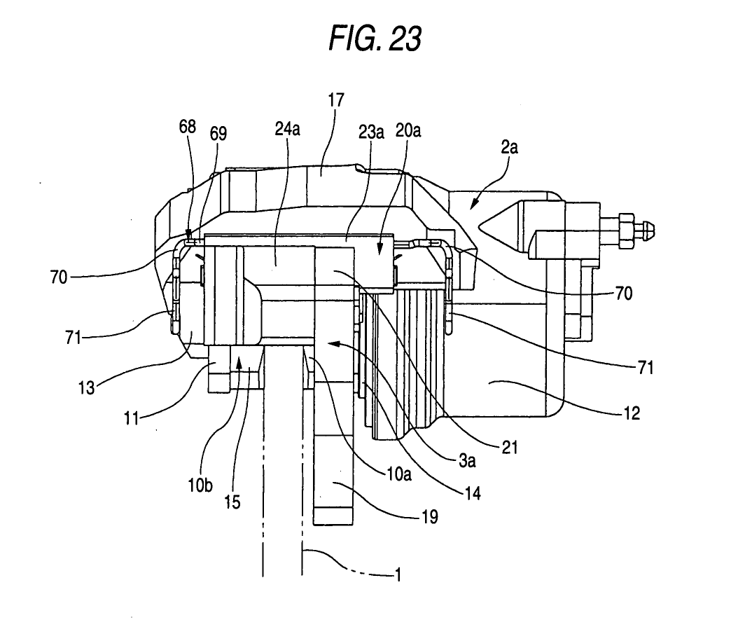

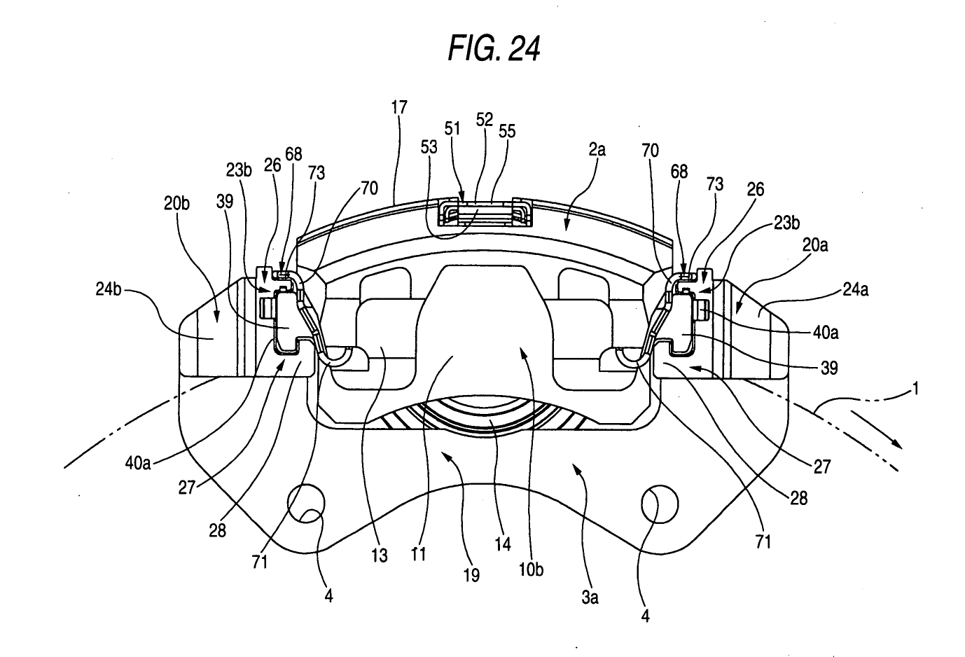

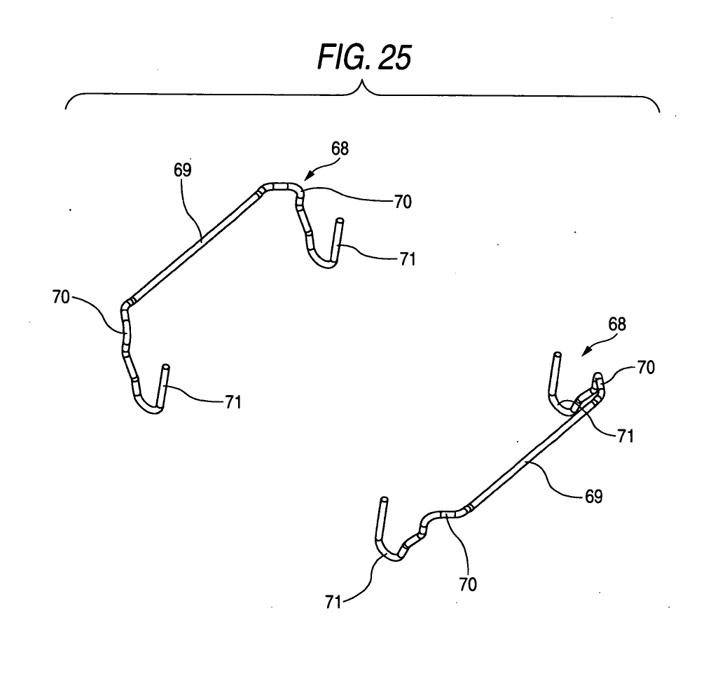

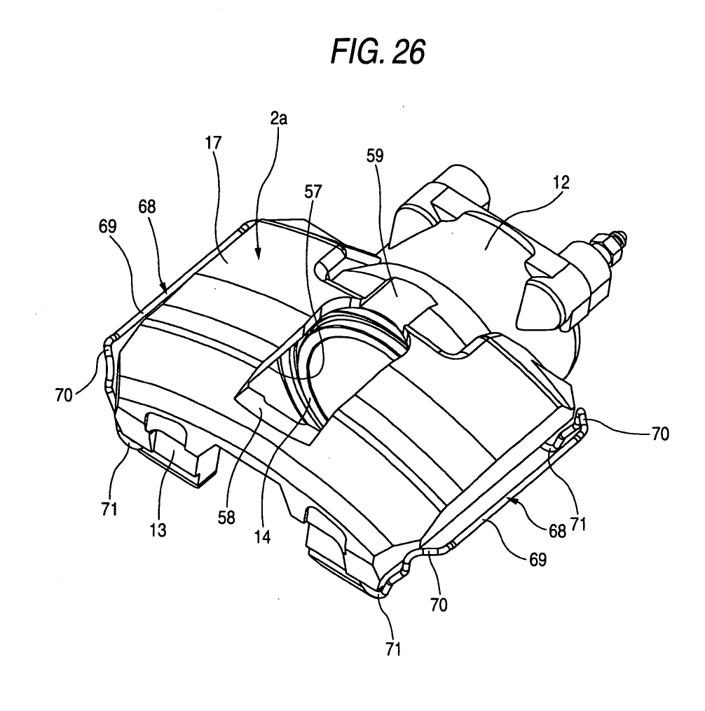

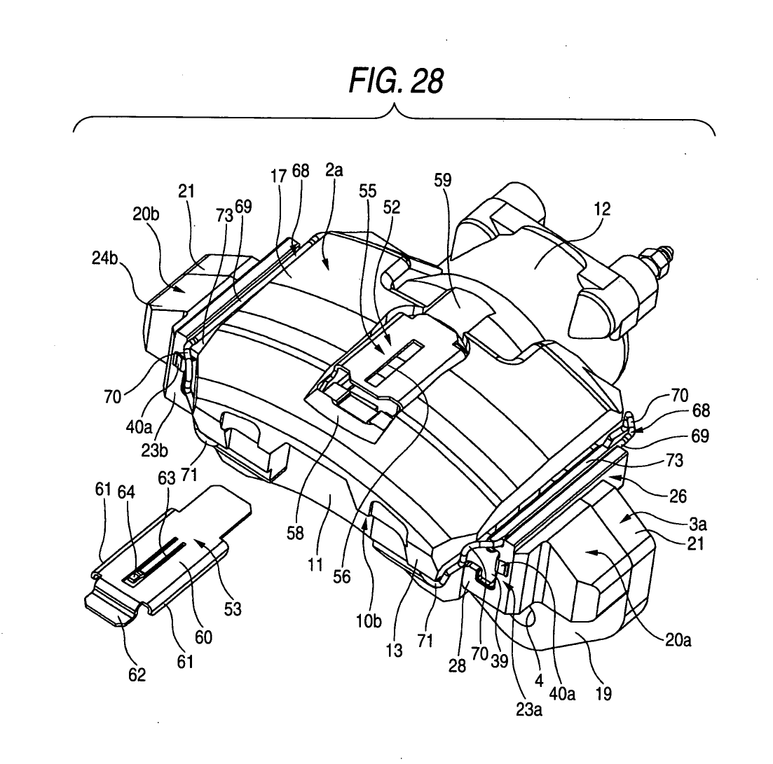

FIGS. 21 to 28 are views showing a floating caliper type disc brake according to a fourth exemplary embodiment of the present invention. The present exemplary embodiment is different from the first to third embodiments at the following points. In the fourth embodiment, the elastic portion 41 (shown in FIG. 1) is not provided in the pad clip 40a, 40a attached to the torque receiving member 20a, 20a composing the support member 3a. Instead of that, in the case of the present exemplary embodiment, on a lower side of both end portions in the width direction (the lateral direction of FIGS. 21, 24, 26 to 28, and the perpendicular direction of FIG. 22) of the caliper 2a, a pair of springs 68, 68 for pushing, which are shown in FIG. 25 in detail, are attached. These springs 68, 68 for pushing are elastically pushed to the support member 3a. These springs 68, 68 for pushing are formed out of wire rods made of metal such as spring steel. Each spring 68, 68 includes: a linear base portion 69; a pair of leg portions 70, 70 connected to both end portions of the base portion 69; and a substantially U-shaped pushing portion 71, 71, each base end portion of which is connected to one end of each leg portion 70, 70. In the case, each leg portion 70, 70 is connected to both end portions of the base portion 69 and spread widely and then curved in a direction (downward of FIG. 25) perpendicular to the longitudinal direction of the base portion 69. Both end portions of each pushing portion 71, 71 are widely spread and the forward end portions are directed to the base portion 69 side (the upper side of FIG. 25).

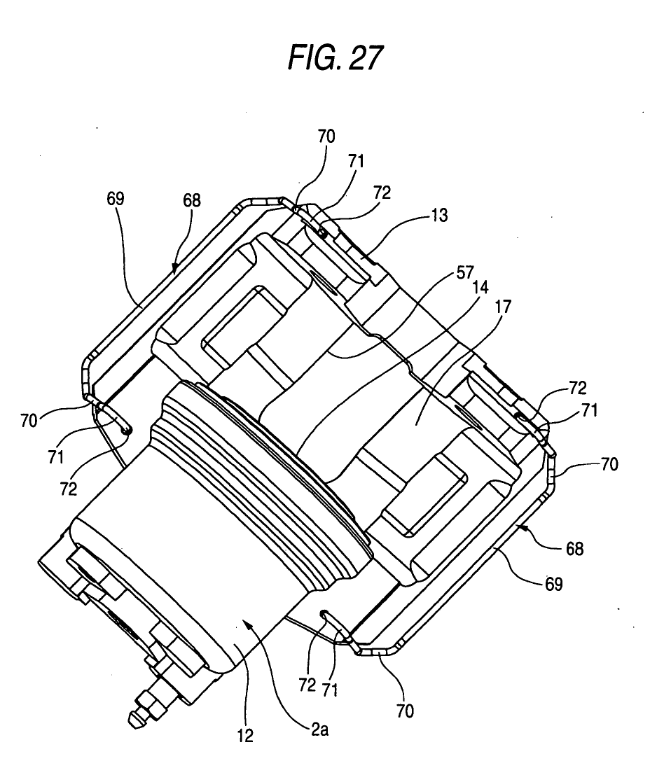

As shown in FIGS. 22 and 27, into the engaging holes 72, 72 formed at both side positions (both side positions in the lateral direction of FIG. 22) crossing the rotor 1 on the lower side of both end portions in the width direction (the vertical direction of FIG. 22) of the caliper 2a, both end portions of the springs 68, 68 are detachably engaged under the condition of crossing the outer circumference of the rotor 1. In the state, the base portions 69, 69 are protruded from both sides in the width direction of the caliper 2a.

The caliper 2a, with which the springs 68, 68 are engaged in the way, is supported by the support member 3a as follows. That is, the base portions 69, 69 of the springs 68, 68 for pushing engaged with the caliper 2a are elastically pushed to and engaged with upper faces of the step portions 73, 73 formed on upper faces of the anchor portions 23a, 23b of the torque receiving members 20a, 20b composing the support member 3a and also engaged with inner sides (faces on the caliper 2a side) of the step portions 73, 73. Therefore, each pushing spring 68, 68 is bent from the free state. By a portion close to the forward end portion of the pushing portion 71, 71 of the pushing spring 68, 68, an elastic force directed to the central side in the width direction of the caliper 2a is given to the engaging hole 72, 72. By an intermediate portion of the pushing portion 71, 71, a periphery of the opening of the engaging hole 72, 72 is elastically pushed upward by the lower side of the caliper 2a. By the pushing spring 68, 68, an elastic force directed to the outside in the radial direction of the rotor 1 and also directed in the circumferential direction is given to the caliper 2a. Inside of a portion protruding outside from the through-hole 57 of the caliper 2a which is a portion close to the bottom plate portion 55 of the holding member 52 engaged with the protrusion 54 (shown in FIGS. 4, 5, 9 and 11) provided in the pressure plate 11, 11 composing the pad 10a, 10b, the lock plate 53 is inserted, so that the caliper 2a can be prevented from moving outside in the radial direction of the rotor 1 with respect to the pad 10a, 10b.

According to the floating caliper type disc brake of the present exemplary embodiment, rattling of the caliper 2a can be suppressed by the springs 68, 68 for pushing. Further, even at the time of applying the disc brakes, the caliper 2a and the springs 68, 68 for pushing do not come into sliding contact with each other. Therefore, being different from a case in which a portion of the elastic member such as a pad spring is being pushed to and slid on the caliper 2a so as to suppress the occurrence of rattling of the caliper 2a, it is unnecessary to provide a surface, which is machined so as to be used for sliding the elastic member, on the caliper 2a. Accordingly, it becomes unnecessary to conduct machining the surface with high accuracy. Further, in the case where the springs 68, 68 for pushing are formed out of wire rods like the present embodiment, a sliding portion, which is formed by an upper face and an inner side of the step portion 73, 73 between the base end portion 69, 69 of the spring 68, 68 for pushing and the torque receiving member 20a, 20b, becomes linear. Therefore, an area of the sliding portion can be reduced. Therefore, the caliper 2a can be more smoothly displaced in the axial direction of the rotor 1 with respect to the support member 3a.

The other structure and action are substantially the same as those of the first exemplary embodiment shown in FIGS. 1 to 15. Therefore, like reference characters are used to indicate like parts and the duplicate explanations are omitted here.

Further, concerning the spring 68, 68 for pushing which is incorporated into the present exemplary embodiment, as long as it can give an elastic force to the caliper 2a outward in the radial direction and in the circumferential direction, any spring may be adopted, and a position of the pushing portion is not particularly limited.

It will be apparent to those skilled in the art that various modifications and variations can be made to the described embodiments of the present invention without departing from the spirit or scope of the invention. Thus, it is intended that the present invention cover all modifications and variations of this invention consistent with the scope of the appended claims and their equivalents.

What is claimed is:

1. A floating caliper type disc brake comprising:
a support member fixed to a vehicle body, being adjacent to a rotor rotated together with a wheel;
a pair of pads arranged on both sides of the rotor in an axial direction of the rotor, guided by the support member being capable of moving in the axial direction; and
a caliper,
wherein the caliper includes:
a bridge portion striding across the rotor and the pair of pads;
a claw portion arranged on one side of a bridge portion; and
a cylinder portion arranged on the other side of the bridge portion, wherein a piston is incorporated to the cylinder portion,
the support member includes:
an inner side attaching member arranged at a position shifted to an inner side with respect to the rotor;
a pair of torque receiving members provided on both end portions in a circumferential direction of the rotor of the inner side attaching member; and
a drawing anchor portion provided on at least one of the pair of the torque receiving members, wherein an end portion of the drawing anchor portion is bent in a radial direction of the rotor, and
wherein an inside surface of the end portion of the drawing anchor at a side in the circumferential direction of the rotor and an engaging portion in one end portion of at least one of the pads are arranged being opposed to each other in the circumferential direction of the rotor.

2. The floating caliper type disc brake according to claim 1, further comprising:
a holder arranged between the caliper and the pair of pads, wherein the caliper is supported to the pads by the holding means being capable of engaging with and disengaging from the support member, while the caliper is slidable in the axial direction of the rotor.

3. The floating caliper type disc brake according to claim 1, wherein the drawing anchor is provided on an anchor portion, the anchor portion being provided on at least one end portion in a longitudinal direction of the one of the pair of the torque receiving members,
the anchor portion includes a recessed groove having two inner wall faces, which are opposed to each other in the radial direction of the rotor, and also having two inner wall faces, which are opposed to each other in the circumferential direction of the rotor, and
the recessed groove is capable of engaging with the engaging portion of the one of the pads, the engaging portion being formed on one end portion of a pressure plate of the one of the pads.

4. The floating caliper type disc brake according to claim 1, wherein the drawing anchor portion is arranged only on an outer side with respect to the rotor of the one of the torque receiving members.

5. The floating caliper type disc brake according to claim 1, wherein the drawing anchor portion is arranged only on an outer side with respect to the rotor of the torque receiving member which is on a rear side in a rotary direction of the rotor in the case where a vehicle advances forward.

6. The floating caliper type disc brake according to claim 1, further comprising:
a pad clip attached to the torque receiving member, wherein the caliper is urged in an outer radial direction and in the circumferential direction of the rotor by the pad clip.

7. The floating caliper type disc brake according to claim 1, further comprising:
a pair of elastic members detachably engaged with both end portions of the caliper with respect to the circumferential direction of the rotor, the pair of elastic members striding across an outer circumference of the rotor, wherein the caliper is urged in an outer radial direction and the circumferential direction of the rotor by the elastic members.

8. A floating caliper type disc brake comprising:
a support member fixed to a vehicle body, being adjacent to a rotor rotated together with a wheel;
a pair of pads arranged on both sides of the rotor in an axial direction of the rotor, guided by the support member being capable of moving in the axial direction;
a caliper,
wherein the caliper includes:
a bridge portion striding across the rotor and the pair of pads;
a claw portion arranged on one side of a bridge portion; and
a cylinder portion arranged on the other side of the bridge portion, wherein a piston is incorporated to the cylinder portion,
the support member includes:
an inner side attaching member arranged at a position shifted to an inner side with respect to the rotor, wherein a pair of through-holes are formed in the inner side attachment member in both end portions in a circumference direction of the rotor; and
a pair of torque receiving members provided on both end portions in a circumferential direction of the rotor of the inner side attaching member, wherein each of the torque receiving member has a protrusion on a inner side surface,
wherein each of the torque receiving members is fastened to the inner side attaching member by inserting the protrusion into the through-hole and caulking a portion of the protrusion protruded from an inner side surface of the inner side attaching member, and a center side surface in a width direction of the inner side attaching member in a vicinity of the through-hole is firmly contact with a side surface of the torque receiving member.
